(19) United States
(12) Patent Application Publication
(10) Pub. No.: US 2009/0103416 A1
(43) Pub. Date: Apr. 23, 2009

(54) LAYOUT METHOD FOR MULTIPLEXED HOLOGRAMS

(75) Inventors: Paul C. SMITH, Louisville, CO (US); Tod R. EARHART, Mead, CO (US); Oyvind HAEHRE, Loveland, CO (US); John MURPHY, Berthoud, CO (US); John J. KANE, Westminster, CO (US); Byron Harris, Firestone, CO (US)

Correspondence Address: JAGTIANI + GUTTAG, 10363-A DEMOCRACY LANE, FAIRFAX, VA, 22030, US

(73) Assignee: INPHASE TECHNOLOGIES, INC., LONGMONT, CO (US)

(21) Appl. No.: 12/210,476

(22) Filed: Sep. 15, 2008

Related U.S. Application Data
(60) Provisional application No. 60/980,604, filed on Oct. 17, 2007.

(51) Int. Cl. G11B 7/00

(52) U.S. Cl. 369/103; G9B/7

(57) ABSTRACT

Methods are disclosed for determining the layout of cure sites/cure spots and/or stack positions on the recordable section of a holographic storage medium. Also disclosed are methods for carrying out pre-curing and stack writing routines for pre-curing, in an appropriate order, bookcases comprising such cure spots in the recordable section, and for writing stacks of holograms, in an appropriate order, to such bookcases after determining such layouts.

### CROSS-REFERENCE TO RELATED APPLICATIONS

This application claims the priority of U.S. Provisional Patent Application No. 60/980,604 entitled “LAYOUT METHOD FOR MULTIPLEXED HOLOGRAMS” filed Oct. 17, 2007, the entire disclosure and contents of which is hereby incorporated by reference. This application also makes reference to the following U.S. patent applications: U.S. Provisional Patent Application No. 61/083,254, entitled “METHOD ALLOWING LOCALIZED GATING OF DIFFUSION PROPERTIES,” filed Jul. 24, 2008. U.S. Provisional Patent Application No. 61/082,328, entitled “METHOD TO MODIFY AND APPLY EDGE SEAL MATERIALS TO LAMINATED MEDIA SO THAT THE RESULTING SEAL HAS MINIMAL EFFECT ON THE SHAPE OF THE MEDIA AFTER EXPOSURE TO ELEVATED TEMPERATURES,” filed Jul. 21, 2008. U.S. Provisional Patent Application No. 61/060,890, entitled “SYSTEM AND DEVICES FOR IMPROVING EXTERNAL CAVITY DIODE LASERS USING WAVELENGTH AND MODE SENSORS AND COMPACT OPTICAL PATHS,” filed Jun. 12, 2008. U.S. Provisional Patent Application No. 61/054,613, entitled “METHOD FOR COMPENSATING FOR THERMAL EFFECTS OF A PHOTOPOLYMER BY USING ADAPTIVE ENERGY CONTROL,” filed May 20, 2008. U.S. Provisional Patent Application No. 61/028,628, entitled “SERVO FOR HOLOGRAPHIC DATA STORAGE,” filed Feb. 14, 2008. U.S. Provisional Patent Application No. 60/855,754, entitled “EMULATION OF DISSIMILAR REMOVABLE MEDIUM STORAGE DEVICE TYPES ASSISTED BY INFORMATION EMBEDDED IN THE LOGICAL FORMAT,” filed Sep. 1, 2006. U.S. patent application Ser. No. 11/849,658, entitled “EMULATION OF DISSIMILAR REMOVABLE MEDIUM STORAGE DEVICE TYPES ASSISTED BY INFORMATION EMBEDDED IN THE LOGICAL FORMAT,” filed Sep. 4, 2007. U.S. Provisional Patent Application No. 60/831,692, entitled “EXTERNAL CAVITY DIODE LASER COLLIMATION GROUP ADJUSTMENT” filed Jul. 19, 2006. U.S. patent application Ser. No. 11/826,517, entitled “COLLIMATION LENS GROUP ADJUSTMENT FOR LASER SYSTEM” filed Jul. 16, 2007. U.S. Provisional Patent Application No. 60/802,530, entitled “HIGH-SPEED ELECTROMECHANICAL SHUTTER” filed May 25, 2006. U.S. patent application Ser. No. 11/752,804, entitled “HIGH-SPEED ELECTROMECHANICAL SHUTTER” filed May 25, 2007. U.S. Provisional Patent Application No. 60/793,322, entitled “METHOD FOR DESIGNING INDEX CONTRASTING MONOMERS” filed Apr. 20, 2006. U.S. Provisional patent application Ser. No. 11/738,394, entitled “INDEX CONTRASTING-PHOTOACTIVE POLYMERIZABLE MATERIALS, AND ARTICLES AND METHODS USING SAME” filed Apr. 20, 2007. U.S. Provisional Patent Application No. 60/780,354, entitled “EXTERNAL CAVITY LASER” filed Mar. 9, 2006. U.S. patent application Ser. No. 11/716,002, entitled “EXTERNAL CAVITY LASER” filed Mar. 9, 2007. U.S. Provisional Patent Application No. 60/779,444, entitled “METHOD FOR DETERMINING MEDIA ORIENTATION AND REQUIRED TEMPERATURE COMPENSATION IN PAGE-BASED HOLOGRAPHIC DATA STORAGE SYSTEMS USING DATA PAGE BRAGG DETUNING MEASUREMENTS” filed Mar. 7, 2006. U.S. patent application Ser. No. 11/714,125, entitled “METHOD FOR DETERMINING MEDIA ORIENTATION AND REQUIRED TEMPERATURE COMPENSATION IN PAGE-BASED HOLOGRAPHIC DATA STORAGE SYSTEMS USING DATA PAGE BRAGG DETUNING MEASUREMENTS” filed Mar. 6, 2007. U.S. Provisional Patent Application No. 60/778,935, entitled “MINIATURE FLEXURE BASED SCANNERS FOR ANGLE MULTIPLEXING” filed Mar. 6, 2006. U.S. Provisional Patent Application No. 60/780,848, entitled “MINIATURE FLEXURE BASED SCANNERS FOR ANGLE MULTIPLEXING” filed Mar. 10, 2006. U.S. Provisional Patent Application No. 60/756,556, entitled “EXTERNAL CAVITY LASER WITH A TUNABLE HOLOGRAPHIC ELEMENT” filed Jan. 6, 2006. U.S. patent application Ser. No. 11/649,801, entitled “AN EXTERNAL CAVITY LASER WITH A TUNABLE HOLOGRAPHIC ELEMENT” filed Jan. 5, 2007. U.S. Provisional Patent Application No. 60/738,597, entitled “METHOD FOR HOLOGRAPHIC DATA RETRIEVAL BY QUADRATURE HOMODYNE DETECTION” filed Nov. 22, 2005. U.S. patent application Ser. No. 11/562,533, entitled “METHOD FOR HOLOGRAPHIC DATA RETRIEVAL BY QUADRATURE HOMODYNE DETECTION” filed Nov. 22, 2006. U.S. patent application Ser. No. 11/402,837, entitled “ARTICLE COMPRISING HOLOGRAPHIC MEDIUM BETWEEN SUBSTRATES HAVING ENVIRONMENTAL BARRIER SEAL AND PROCESS FOR PREPARING SAM” filed Dec. 2, 2005. U.S. patent application Ser. No. 11/291,845, entitled “ARTICLE COMPRISING HOLOGRAPHIC MEDIUM BETWEEN SUBSTRATES HAVING ENVIRONMENTAL BARRIER SEAL AND PROCESS FOR PREPARING SAM” filed Dec. 2, 2005. U.S. Provisional Patent Application No. 60/728,768, entitled “METHOD AND SYSTEM FOR INCREASING HOLOGRAPHIC DATA STORAGE CAPACITY USING IRRADIANCE-TAILORING ELEMENT” filed Oct. 21, 2005. U.S. patent application Ser. No. 11/319,425, entitled “METHOD AND SYSTEM FOR INCREASING HOLOGRAPHIC DATA STORAGE CAPACITY USING IRRADIANCE-TAILORING ELEMENT” filed Dec. 27, 2005. U.S. Provisional Application No. 60/684,531, entitled “METHODS FOR MAKING A HOLOGRAPHIC STORAGE DRIVE SMALLER, CHEAPER, MORE ROBUST AND WITH IMPROVED PERFORMANCE” filed May 26, 2005. U.S. application Ser. No. 11/440,368, entitled “REPLACEMENT AND ALIGNMENT OF LASER” filed May 25, 2006. U.S. application Ser. No. 11/440,369, entitled “HOLOGRAPHIC DRIVE HEAD ALIGNMENTS” filed May 25, 2006. U.S. application Ser. No. 11/440,365, entitled “LASER MODE STABILIZATION USING AN ETALON” filed May 25, 2006. U.S. application Ser. No. 11/440,366, entitled “ERASING HOLOGRAPHIC MEDIA” filed May 25, 2006. U.S. application Ser. No. 11/440,367, entitled “POST-CURING OF HOLOGRAPHIC MEDIA” filed May 25, 2006. U.S. application Ser. No. 11/440,371, entitled “SENSING ANGULAR ORIENTATION OF HOLOGRAPHIC MEDIA IN A HOLOGRAPHIC MEMORY SYSTEM” filed May 25, 2006. U.S. application Ser. No. 11/440,372, entitled “SENSING ABSOLUTE POSITION OF AN ENCODED OBJECT” filed May 25, 2006. U.S. application Ser. No. 11/440,357, entitled “CONTROLLING THE TRANSMISSION AMPLITUDE PROFILE OF A COHERENT LIGHT BEAM IN A HOLOGRAPHIC MEMORY SYSTEM” filed May 25, 2006. U.S. application Ser. No. 11/440,358, entitled “OPTICAL DELAY LINE IN HOLOGRAPHIC DRIVE” filed May 25, 2006. U.S. application Ser. No. 11/440,359, entitled “HOLOGRAPHIC DRIVE HEAD AND COMPONENT ALIGNMENT” filed May 25, 2006. U.S. application Ser. No. 11/440,448, entitled “IMPROVED OPERATIONAL MODE PERFORMANCE OF A HOLOGRAPHIC MEMORY SYSTEM” filed May 25, 2006. U.S. application Ser. No. 11/440,447, entitled “PHASE CONJUGATE RECONSTRUCTION OF A HOLOGRAM” filed May 25, 2006. U.S. application Ser. No. 11/440,446, entitled “METHODS AND SYSTEMS FOR LASER MODE STABILIZATION” filed May 25, 2006. U.S. application Ser. No. 11/440,370, entitled “METHODS FOR MAKING A HOLOGRAPHIC STORAGE DRIVE SMALLER, CHEAPER, MORE ROBUST AND WITH IMPROVED PERFORMANCE” filed May 25, 2006. U.S. application Ser. No. 11/447,033, entitled “SIMPLIFICATION OF A HOLOGRAPHIC DATA STORAGE (HDS) CARTRIDGE LOAD MECHANISM” filed Jun. 6, 2006. U.S. application Ser. No. 11/283,864, entitled “DATA STORAGE CARTRIDGE LOADING AND UNLOADING MECHANISM, DRIVE DOOR MECHANISM AND DATA DRIVE” filed Nov. 22, 2006. U.S. application Ser. No. 11/237,883, entitled “LOW CTE MEDIA FOR HOLOGRAPHIC RECORDING BY PROVIDING A SLIP LAYER BETWEEN THE MEDIA AND ITS SUBSTRATES” filed Sep. 29, 2005. U.S. application Ser. No. 11/261,840, entitled “SHORT STACK RECORDING IN HOLOGRAPHIC MEMORY SYSTEMS” filed Dec. 2, 2005. U.S. application Ser. No. 11/067,010, entitled “HIGH FIDELITY HOLOGRAM DEVELOPMENT VIA CONTROLLED POLYMERIZATION” filed Feb. 28, 2005. U.S. Provisional Application No. 60/576,381, entitled “METHOD FOR ORGANIZING AND PROTECTING DATA STORED ON HOLOGRAPHIC MEDIA BY USING ERROR CONTROL AND CORRECTION TECHNIQUES AND NEW DATA ORGANIZATION STRUCTURES” filed Jun. 3, 2004. U.S. application Ser. No. 11/139,806, entitled “DATA PROTECTION SYSTEM” filed May 31, 2005. U.S. application Ser. No. 11/140,151, entitled “MULTI-LEVEL FORMAT FOR INFORMATION STORAGE” filed May 31, 2005. U.S. application Ser. No. 10/866,823, entitled “THERMOPLASTIC HOLOGRAPHIC MEDIA” filed Jun. 15, 2004. The entire disclosure and contents of the above applications are hereby incorporated by reference.

### BACKGROUND

1. Field of the Invention

The present invention broadly relates to holographic data storage methods to achieve higher transfer rates and data storage capacities in a holographic storage medium multiplexing multiple stacks of holograms, while at the same time avoiding or minimizing problems that might occur when using such holographic data storage methods to achieve such higher transfer rates and data storage capacities.

2. Related Art

Developers of information storage devices and methods continue to seek increased storage capacity. As part of this development, holographic memory systems have been suggested as alternatives to conventional memory devices. Holographic memory systems may be designed to record data as one bit of information (i.e., bit-wise data storage). See McLeod et al. “Micro-Holographic Multi-Layer Optical Disk Data Storage,” International Symposium on Optical Memory and Optical Data Storage (July 2005). Holographic memory systems may also be designed to record an array of data that may be a 1-dimensional linear array (i.e., a 1×N array, where N is the number linear data bits), or a 2-dimensional array commonly referred to as a “page-wise” memory system. Page-wise memory systems may involve the storage and readout of an entire two-dimensional representation, e.g., a page of data. Typically, recording light passes through a two-dimensional array of low and high transparency areas representing data, and the system stores, in three dimensions, the pages of data holographically as patterns of varying refractive index imprinted into a storage medium. See Psaltis et al., “Holographic Memories,” Scientific American, November 1995, where holographic systems are discussed generally, including page-wise memory systems.

Holographic data storage systems may perform a data write (also referred to as a data record or data store operation, which may be referred to herein as a “write” operation) by combining two coherent light beams, such as laser beams, at a particular point within the storage medium. Specifically, a data-encoded light beam may be combined with a reference light beam to create an interference pattern in the holographic storage medium. The pattern created by the interference of the data beam and the reference beam forms a hologram which may then be recorded in the holographic storage medium. If the data-bearing beam is encoded by passing the data beam through, for example, a spatial light modulator (SLM), the hologram(s) may be recorded in the holographic storage medium.

Holographically-stored data may then be retrieved from the holographic data storage system by performing a read (or reconstruction) of the stored data. The read operation may be performed by projecting a reconstruction or probe beam into the storage medium at the same angle, wavelength, phase, position, etc., as the reference beam used to record the data, or compensated equivalents thereof. The hologram and the reference beam interact to reconstruct the data beam.

In a holographic data storage system, information is recorded, for example, by making changes to the physical (e.g., optical) and chemical characteristics of the holographic storage medium. These changes in the holographic storage medium take place in response to the local intensity of the recording light. That intensity may be modulated by the interference between a data-bearing beam (the data beam) and a non-data-bearing beam (the reference beam). The pattern created by the interference of the data beam and the reference beam forms a hologram which may then be recorded in the holographic storage medium. If the data-bearing beam is encoded by passing the data beam through, for example, a spatial light modulator (SLM), the hologram(s) may be recorded in the holographic storage medium as an array of light and dark squares or pixels. The holographic storage medium or at least the recorded portion thereof with these arrays of light and dark pixels may be subsequently illuminated with a reference beam (sometimes referred to as a reconstruction beam) of the same or similar wavelength, phase, etc., so that the recorded data may be read.

One type of holographic storage medium which may be used for such holographic data storage systems are photosensitive polymer films. Photosensitive polymer films may provide for high density holographic data storage, at a relatively low cost, may be easily processed and may be designed to have large index contrasts with high photosensitivity. These films may also be fabricated with the dynamic range, media thickness, optical quality and dimensional stability required for high density applications. See, e.g., L. Dhar et al., “Recording Media That Exhibit High Dynamic Range for Holographic Storage,” Optics Letters, 24, (1999): pp. 487 et. seq; Smothers et al., “Photopolymers for Holography,” SPIE OE/Laser Conference, (Los Angeles, Calif., 1990), pp.: 1212-03.

The holographic storage media described in, for example, Smothers et al., supra, may contain a photoimageable system containing a liquid monomer material (the photoactive monomer) and a photoinitiator (which promotes the polymerization of the monomer upon exposure to light), where the photoimageable system is in an organic polymer host matrix that is substantially inert to the exposure light. During writing (recording) of data into the holographic storage medium, the monomer polymerizes in the exposed regions. Due to the lowering of the monomer concentration caused by the polymerization, monomer from the dark, unexposed regions of the material diffuses to the exposed regions. The polymerization and resulting diffusion create a refractive index change, thus forming the hologram representing the data.

High information density may be achieved through writing/recording and storing many holograms on top of one another in a holographic storage medium. A technique for achieving such high information density data storage is by multiplexing holograms. Multiplexing of holograms involves storing multiple holograms in the holographic storage medium, often in the same volume or nearly the same volume of the medium.

These multiplexing methods may include, for example, angular (angle) multiplexing, polytopic multiplexing, peristrophic multiplexing, wavelength multiplexing, phase-coded multiplexing, fractal multiplexing, shift multiplexing, confocal multiplexing, etc., as well as combinations of these methods. Each of these multiplexing methods may write a stack of many holograms in one spatial location in the holographic storage medium. Many of these methods rely on a holographic phenomenon known as the Bragg effect to separate the holograms even though they are physically located within the same volume of media. Some of these multiplexing methods, such as shift and, to some extent correlation, use the Bragg effect and relative motion of the media and input laser beams to overlap multiple holograms in the same volume of the media. See, for example, U.S. Pat. No. 6,322,933, (Daiber et al.), issued Nov. 27, 2001; and U.S. Pat. No. 7,092,133 (Anderson et al.), issued Aug. 15, 2006, which describe several examples of techniques for multiplexing of holograms in holographic storage media.

### SUMMARY

According to a first broad aspect of the present invention, there is provided a method comprising the following steps:
(a) providing a holographic storage medium having a recordable section comprising a plurality of bookcases having one or more cure sites, each cure site corresponding to one cure spot, wherein one or more pre-cure boundaries are established to define one or more a bounded pre-cure areas comprising one or more bookcases; and
(b) for each bounded pre-cure area, carrying out a pre-curing and stack writing routine at the one or more cure sites within the one or more of the bookcases such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases within a pre-cure active recording period.

According to a second broad aspect of the present invention, there is provided a method comprising the following steps:
(a) providing a holographic storage medium having a recordable section comprising first bounded pre-cure area and a second bounded pre-cure area, wherein each of the first and second bounded pre-cure areas comprise one or more bookcases, each bookcase having one or more cure sites;
(b) within the first bounded pre-cure area and for the one or more bookcases within the first bounded pre-cure area, carrying out a pre-curing and stack writing routine at the one or more cure sites within the one or more bookcases of the first bounded pre-cure area such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases of the first bounded pre-cure area within a first pre-cure active recording period; and
(c) after step (b) is completed, within the second bounded pre-cure area and for the one or more bookcases within the second bounded pre-cure area, carrying out a pre-curing and stack writing routine at the one or more cure sites within the one or more bookcases of the second bounded pre-cure area such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases of the second bounded pre-cure area within a second pre-cure active recording period.

According to a third broad aspect of the present invention, there is provided a method comprising the following steps:
(a) determining the positioning of a multiplicity of cure sites on a recordable section of a holographic storage medium so as to provide corresponding cure spots having a constant intensity profile across the entire recordable section, wherein each cure site corresponds to one of the cure spots;
(b) determining the positioning of all stacks of holograms to be written to the recordable section such that each stack of holograms can be written to at least one of the cure spots;
(c) determining which of the at least one cure spots each of the stacks of holograms will be written to; and
(d) determining which of the cure spots are to be grouped into each of a plurality of bookcases.

According to a fourth broad aspect of the present invention, there is provided a method comprising the following steps:
(a) determining which of a multiplicity of cure spots are to be grouped into each of a plurality of bookcases to be positioned on a recordable section of a holographic storage medium, wherein each cure spot corresponds to one cure site having a position on the recordable section;
(b) from all stacks of holograms to be written to the recordable section, determining which of the stacks of holograms are to be written to each bookcase; and
(c) for each bookcase, determining where each bookcase is to be positioned on the recordable section based on the position of the cure site for each cure spot within each bookcase.

According to a fifth broad aspect of the present invention, there is provided a method comprising the following steps:
(a) providing a holographic storage medium having a recordable section comprising a plurality of bookcases, wherein each bookcase is positioned on the recordable section by using each cure site for each cure spot to be included within the bookcase and wherein each cure site is arranged in a row;
(b) for each bookcase, carrying out a first pre-curing and stack writing routine which comprises the steps of: (1) pre-curing a first cure spot within a first row and within the bookcase; (2) pre-curing all cure spots neighboring the first cure spot and which are not within a different bounded pre-cure area so as to provide a first pre-cured area having a constant intensity profile; and (3) writing one or more stacks of holograms to the first cure spot within the first row;
(c) for each bookcase when step (b) reaches the point where a stack of holograms is to be written to a second cure spot which has been pre-cured within the bookcase, carrying out a second pre-curing and stack writing routine which comprises the steps of: (1) pre-curing all cure spots neighboring the second cure spot which have not been pre-cured and which are not within a different bounded pre-cure area so as to provide a second pre-cured area having a constant intensity profile; and (2) writing one or more stacks of holograms to the second cure spot;
(d) as stacks of holograms to be written for each additional pre-cured cure spot after the second cure spot within the bookcase has been reached, repeating step (c) until all stacks of holograms to be written to the bookcase have been written; and
(e) repeating steps (b) through (d) until all stacks of holograms to be written to the bookcases have been written.

### BRIEF DESCRIPTION OF THE DRAWINGS

The invention will be described in conjunction with the accompanying drawings, in which:

FIG. 1 is a top plan view of a diagram of a holographic storage medium in the form of a disk which shows the positioning and arrangement of cure sites/cure spots which may be pre-cured and tiled across the recordable section of the disk according to an embodiment of the method of the present invention;

FIG. 2 is an enlarged top plan view of a single cure spot from the disk of FIG. 1;

FIG. 3 is a side view to illustrate the pre-cure intensity profile of the single cure spot of FIG. 2;

FIG. 4 is an enlarged top plan view of a pair of overlapping or tiled cure spots from the disk of FIG. 1;

FIG. 5 is a side view of the overlapping pre-cure intensity profiles of the overlapping or tiled cure spots of FIG. 5;

FIG. 6 is a top plan view of a diagram of the disk of FIG. 1 to illustrate an embodiment of a bookcase layout;

FIG. 7 is a top plan view of a diagram of the disk of FIG. 1 illustrating the disk of FIG. 1 with a pre-cure boundary, as well as cure spots which have been pre-cured and stacks of holograms have been written to the disk;

FIG. 8 is an enlarged view of the square breakout area from FIG. 7 to better illustrate the layout of the cure spots which have been pre-cured, along with the stacks of holograms which have been written; and

FIGS. 9 and 10 are enlarged schematic diagrams illustrating a first and second step of an embodiment of a pre-curing and stack writing routine according to the method of the present invention which follows the pre-cure neighboring cure spot rule.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

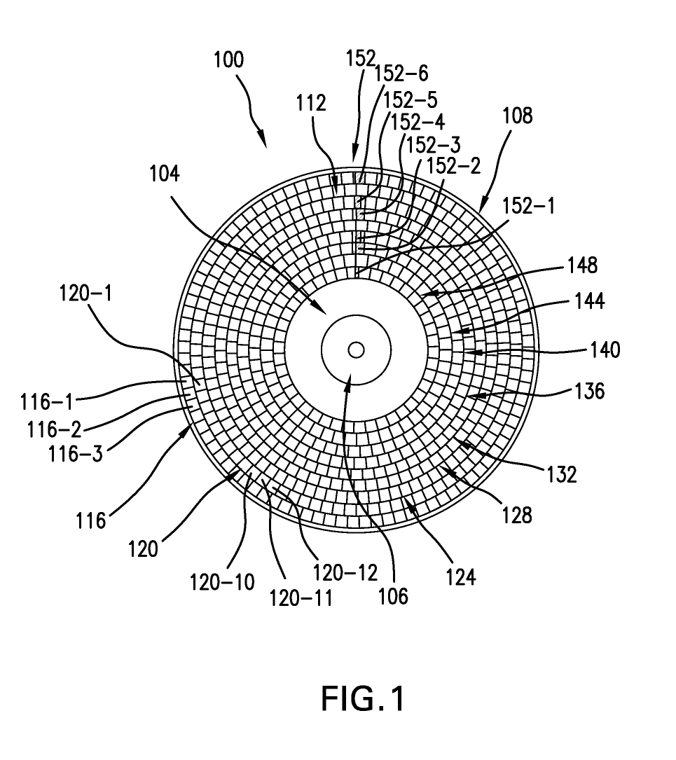

For the purposes of the present invention, directional terms such as “top”, “bottom”, “above”, “below”, “left”, “right”, “horizontal”, “vertical”, “upward”, “downward”, etc. are merely used for convenience in describing the various embodiments of the present invention. The embodiments of the present invention may be oriented in various ways. For example, the embodiments shown in FIGS. 1 through 18 may be flipped over, rotated by 90° in any direction, etc.

For the purposes of the present invention, the term “coherent light beam” refers to a beam of light including waves with a particular (e.g., constant) phase relationship, such as, for example, a laser beam. A coherent light beam may also be referred to as light in which the phases of all electromagnetic waves at each point on a line normal to the direction of the light beam are identical, and may also include partially coherent light and light with finite or limited coherence length that many light sources have or provide.

For the purposes of the present invention, the term “data beam” refers to a beam containing a data signal. For example, a data beam may include beams that have been modulated by a modulator such as a spatial light modulator (SLM), along with a beam generated in response to a reference beam impingent on a holographic storage medium, where the generated beam includes data. The modulation of the data beam may be an amplitude, a phase or some combination of the amplitude and phase. The SLM may be reflective or transmissive. The data beam may be modulated into a binary state or into a plurality of states. The data beam may include data as well as headers that contain information about the data to be stored or where the data is stored. The data beam may also include known bits for a servo or to detect the location of the data once it is detected by or on a detector such as, for example, a CMOS sensor array.

For the purposes of the present invention, the term “data modulated beam” refers to a data beam that has been modulated by a modulator such as a spatial light modulator (SLM). The modulation of the data beam may be an amplitude, a phase or some combination of the amplitude and phase. The SLM may be reflective or transmissive. The data beam may be modulated into a binary state or into a plurality of states.

For the purposes of the present invention, the term “data modulator” refers to any device that is capable of optically representing data in a single bit or in one or two-dimensions from a signal beam.

For the purposes of the present invention, the term “holographic data” refers to data recorded, stored, written, etc., in the holographic storage medium as one or more holograms.

For the purposes of the present invention, the term “data page” or “page” refers to the conventional meaning of data page as used with respect to holography. For example, a data page may be a page of data (i.e., a two-dimensional assembly of data), one or more pictures, etc., to be written or written in a holographic storage medium. The data page may include header information and known bits for servo and channel usage, as well as bits that represent the data to be stored or processed.

For the purposes of the present invention, the term “disk” refers to a disk-shaped holographic storage medium.

For the purposes of the present invention, the terms “holographic grating,” “holograph” or “hologram” (collectively and interchangeably referred to hereafter as “hologram”) are used in the conventional sense of referring to an interference pattern formed when a signal beam and a reference beam interfere with each other. In cases wherein digital data is recorded page-wise, the signal beam may be encoded with a data modulator, e.g., a spatial light modulator, etc.

For the purposes of the present invention, the term “storage medium” refers to any component, material, etc., capable of storing information, such as, for example, a holographic storage medium.

For the purposes of the present invention, the term “holographic storage medium” refers to medium that has a least one component, material, layer, etc., that is capable of recording, storing, writing, etc., one or more holograms (e.g., bit-wise, linear array-wise or page-wise) as one or more patterns of varying refractive index imprinted into the medium. Examples of a holographic storage medium useful herein include, but are not limited to, those described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), issued Aug. 24, 2004; U.S. Patent Application No. 2003/0206320 (Cole et al.) published Nov. 6, 2003; and U.S. Patent Application No. 2004/0027625 (Trentler et al.), published Feb. 12, 2004, the entire disclosure and contents of which are herein incorporated by reference. The holographic storage medium may comprise photopolymers, photo-chromatic, materials, photo-refractive materials, etc. The holographic storage medium may be any type, including: a transparent holographic storage medium, a holographic storage medium including a plurality of components or layers such as a reflective layer, a holographic storage medium including a reflective layer and a polarizing layer so reflection may be controlled with polarization, a holographic storage medium including variable beam transmission layer that may be pass, absorb, reflect, be transparent to, etc., light beams, grating layers for reflecting light beams, substrates, substrates with servo markings, etc. The storage medium may be highly transmissively flat (thus making multiplexing easier and better) or not flat. An example of an inexpensive flat storage medium (e.g., to better than a couple wavelengths within the area where data may be stored may use what is referred to herein as the Zerowave process, which is described in U.S. Pat. No. 6,156,425 (Bouquerel et al.), issued Dec. 5, 2000, the entire disclosure and contents of which is hereby incorporated by reference. All holographic storage medium described herein may be, for example, in the shape, form, etc., of a disk, card, flexible tape media, etc.

For the purposes of the present invention, the term “substrate” refers to components, materials, etc., such as, for example, glass plates or plastic plates, which are associated with the holographic storage medium, and which often provide a supporting structure for the holographic storage medium. Substrates may also optionally provide other beneficial properties for the article, e.g., rendering the holographic storage medium optically flat, etc.

For the purposes of the present invention, the term “support matrix” refers to a material, medium, substance, etc., of a holographic storage medium in which a polymerizable component may be dissolved, dispersed, embedded, enclosed, etc. The support matrix may be a low T_{g} polymer, may be organic, inorganic, or a mixture of the two, and may also be either a thermoset or thermoplastic.

For the purposes of the present invention, the term “oligomer” refers to a polymer having approximately 30 repeat units or less or any large molecule able to diffuse at least about 100 nm in approximately 2 minutes at room temperature when dissolved in a holographic storage medium of the present invention. Such oligomers may contain one or more polymerizable groups whereby the polymerizable groups may be the same or different from other possible monomers in the polymerizable component. Furthermore, when more than one polymerizable group is present on the oligomer, they may be the same or different. Additionally, oligomers may be dendritic. Oligomers are considered herein to be photoactive monomers, although they are sometimes referred to as photoactive oligomer(s).

For the purposes of the present invention, the term “photopolymerization” refers to any polymerization reaction caused by exposure to a photoinitiating light source.

For the purposes of the present invention, the term “free radical polymerization” refers to any polymerization reaction that is initiated by any molecule comprising a free radical or radicals.

For the purposes of the present invention, the term “cationic polymerization” refers to any polymerization reaction that is initiated by any molecule comprising a cationic moiety or moieties.

For the purposes of the present invention, the term “anionic polymerization” refers to any polymerization reaction that is initiated by any molecule comprising an anionic moiety or moieties.

For the purpose of the present invention, the term “photoinitiator” refers to the conventional meaning of the term photoinitiator and also refers to sensitizers and dyes. In general, a photoinitiator causes the light initiated polymerization of a material, such as a photoactive oligomer or monomer, when the material containing the photoinitiator is exposed to light of a wavelength that activates the photoinitiator, i.e., a photoinitiating light source. The photoinitiator may refer to a combination of components, some of which individually are not light sensitive, yet in combination are capable of initiating polymerization of a polymerizable material (e.g., a photoactive oligomer or monomer), examples of which include a dye/amine, a sensitizer/iodonium salt, a dye/borate salt, etc.

For the purposes of the present invention, the term “photoinitiator component” refers to a single photoinitiator or a combination of two or more photoinitiators. For example, two or more photoinitiators may be used in the photoinitiator component to allow recording at two or more different wavelengths of light.

For the purposes of the present invention, the term “polymerizable component” refers to a mixture of one or more photoactive polymerizable materials, and possibly one or more additional polymerizable materials (i.e., monomers and/or oligomers) that are capable of forming a polymer.

For the purposes of the present invention, the term “photoactive polymerizable material” refers to a monomer, an oligomer and combinations thereof that polymerize by being exposed to a photoinitiating light source, e.g., recording light, either in the presence or absence of a photoinitiator that has been activated by the photoinitiating light source. In reference to the functional group that undergoes polymerization, the photoactive polymerizable material comprises at least one such functional group. It is also understood that there exist photoactive polymerizable materials that are also photoinitiators, such as N-methylmaleimide, derivatized acetophenones, etc. In such a case, it is understood that the photoactive monomer and/or oligomer may also be a photoinitiator.

For the purposes of the present invention, the term “photopolymer” refers to a polymer formed by one or more photoactive polymerizable materials, and possibly one or more additional monomers and/or oligomers.

For the purposes of the present invention, the term “thermoplastic” refers to the conventional meaning of thermoplastic, i.e., a composition, compound, material, medium, substance, etc., that exhibits the property of a material, such as a high polymer, that softens when exposed to heat and generally returns to its original condition when cooled to room temperature. Examples of thermoplastics include, but are not limited to: poly(methyl vinyl ether-alt-maleic anhydride), poly(vinyl acetate), poly(styrene), poly(ethylene), poly(propylene), cyclic olefin polymers, poly(ethylene oxide), linear nylons, linear polyesters, linear polycarbonates, linear polyurethanes, etc.

For the purposes of the present invention, the term “room temperature” refers to the commonly accepted meaning of room temperature, i.e., an ambient temperature of 20°-25° C.

For the purposes of the present invention, the term “thermoset” refers to the conventional meaning of thermoset, i.e., a composition, compound, material, medium, substance, etc., that is crosslinked such that it does not have a melting temperature. Examples of thermosets are crosslinked poly(urethanes), crosslinked poly(acrylates), crosslinked poly(styrene), etc.

For the purposes of the present invention, the term “holographic recording” refers to the act of recording, storing, writing, etc., a hologram in a holographic storage medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data.

For the purposes of the present invention, the term “light source” refers to a source of electromagnetic radiation having a single wavelength or multiple wavelengths. The light source may be from a laser, one or more light emitting diodes (LEDs), etc.

For the purposes of the present invention, the term “photoinitiating light source” refers to a light source that activates a photoinitiator, a photoactive polymerizable material, a photoreactive material or any combination thereof. Photoinitiating light sources may include recording light, etc.

For the purposes of the present invention, the term “photoreactive material” refers to a material that can form a holographic grating with recording light, but is not necessarily from photopolymerization, and has the property of being erasable (reversible grating formation) upon exposure to a light source of a wavelength different from the recording wavelength.

For the purposes of the present invention, the term “photoactive luminescent materials” refers to materials which emit light depending upon their environment. For instance, many of the photoinitiators may have an inherent fluorescence, phosphorescence, or both. The photoproducts of the photoinitiators often have a different fluorescence or phosphorescence characteristic, as well as photoreactive components in that luminescence characteristics may change depending upon the light exposure history. A photoactive luminescent material which is not a photoinitiator, the by products of the photoinitiator, or a photoreactive material may be used. For example, some monomers may fluoresce in the unpolymerized state but do not fluoresce in the polymerized state. Also, some luminescent materials may not fluoresce in the presence of oxygen (or vice versa). Such changes in luminescence may enable the monitoring of the status of the holographic storage medium at any given time. Such monitoring may be accomplished by detectors (e.g., a camera) and by the use of optical filters which select for specific wavelengths.

For the purposes of the present invention, the term “processor” refers to a device capable of, for example, executing instructions, implementing logic, calculating and storing values, etc. Exemplary processors may include application specific integrated circuits (ASIC), central processing units, microprocessors, such as, for example, microprocessors commercially available from Intel and AMD, etc.

For the purposes of the present invention, the terms “recording,” “storing,” and “writing (collectively and interchangeably referred to hereafter as “writing”) refer to recording, storing or writing holograms to and/or into a holographic storage medium.

For the purposes of the present invention, the term “recording light” refers to a light source used to write holograms to a holographic storage medium.

For the purposes of the present invention, the term “reference beam” refers to a beam of light not modulated with data. Exemplary reference beams include non-data bearing laser beams used while writing holograms to, or recovering holograms from, a holographic storage medium. In some embodiments, the reference beam may refer to the original reference beam used to write the hologram, to a reconstruction beam when used to recover holograms from the holographic storage medium, or to the phase conjugate of the original reference (reconstruction) beam.

For the purposes of the present invention, the term “multiplexing” refers to writing a plurality of holograms in the same volume or nearly the same volume of the holographic storage medium by varying a writing parameter(s) including, but not limited to, angle, wavelength, phase code, polytopic, shift, correlation, peristrophic, fractal, etc., including combinations of parameters, e.g., angle-polytopic multiplexing. For example, angle multiplexing involves varying the angle of the plane wave or nearly plane wave of the reference beam during writing to store a plurality of holograms in the same volume. The multiplexed holograms that are written may be, recovered by using/changing the same writing parameter(s) used to write the respective holograms.

For the purposes of the present invention, the term “polytopic multiplexing” refers to a multiplexing method or technique where the writing stacks of holograms is spatially overlapped. The spacing between books may be at least the beam waist, which is the narrowest part of the signal beam. An aperture may be placed in the system at the beam waist. During recovery, all of the overlapped holograms at a given multiplexing angle may be recovered, but only the hologram that is centered in the aperture is passed through to the recovery optics. Examples of polytopic recording techniques that may be used in various embodiments of the present invention are described in U.S. Pat. App. No. 2004/0179251 (Anderson et al.), published Sep. 16, 2004; and U.S. Pat. App. No. 2005/0036182 (Curtis et al.), published Feb. 17, 2005, the entire disclosure and contents of which are hereby incorporated by reference.

For the purposes of the present invention, the term “fractal multiplexing” refers to multiplexing where the angle is changed in a direction which not as Bragg selective until the reconstruction is moved off the detector (e.g., camera).

For the purposes of the present invention, the term “refractive index profile” refers to a three-dimensional (X, Y, Z) mapping of the refractive index pattern recorded in a holographic storage medium.

For the purposes of the present invention, the term “dynamic range” or “M#” of a material refers to a conventional measure of how many holograms at a particular diffraction efficiency may be multiplexed at a given location in the material (e.g., recording material layer, holographic storage medium, etc.) and is related to the materials index change, material thickness, wavelength of light, optical geometry, etc.

For the purposes of the present invention, the term “diffraction efficiency” refers to the fraction or percentage of incident light is diffracted by the hologram being either recovered or reconstructed.

For the purposes of the present invention, the term “percentage of dynamic range used” refers to how much of the dynamic range of a holographic storage medium has been used, relative to the total dynamic range capacity of the medium. For example, assuming all multiplexed holograms overlapping in a given volume have an equal diffraction efficiency, M#, the diffraction efficiency (DE) may be related by the following equation: DE=(M#/n)², wherein n is the number of holograms multiplexed in that volume.

For the purposes of the present invention, the term “spatial light modulator” (SLM) refers to a device that stores information on a light beam by, for example, modulating the spatial intensity and/or phase profile of the light beam.

For the purposes of the present invention, the term “spatial light intensity” refers to a light intensity distribution or pattern of varying light intensity within a given volume of space.

For the purposes of the present invention, the term “recordable section of the holographic storage medium” refers to that portion or portions of the holographic storage medium to which holograms may written.

For the purposes of the present invention, the term “recovering holograms” refers to retrieving, recovering, reconstructing, reading, etc., holograms written to a holographic storage medium.

For the purposes of the present invention, the term “non-recording light” refers to a light source that does not or is not intended to write holograms to a holographic storage medium. Non-recording light may include non-information bearing light.

For the purposes of the present invention, the term “illuminative treatment beam” refers any non-recording light beam used to carry out illuminative curing or illuminative erasing.

For the purposes of the present invention, the term “curing beam” refers to a non-recording light beam used to carry out illuminative curing of a holographic storage medium.

For the purposes of the present invention, the term “erasing beam” refers to a non-recording light beam used to carry out illuminative erasing of a holographic storage medium.

For the purposes of the present invention, the terms “uniform intensity light” and “constant intensity light” refer interchangeably to a light source that is spatially uniform (e.g., is non-Gaussian) in intensity.

For the purposes of the present invention, the term “non-uniform intensity light” refers to a light source that is not spatially uniform (e.g., is Gaussian) in intensity.

For the purposes of the present invention, the term “substantially uniform intensity distribution” (also known as “substantially uniform illumination profile”) refers to an area or volume wherein the intensity of light is substantially the same everywhere in that area or volume, typically with less than about 20% variation in intensity.

For the purposes of the present invention, the term “illuminative treatment” refers to any treatment of a holographic storage medium with a non-recording light beam for the purpose of altering, changing, etc., the properties, physical characteristics, ability, capability, etc., of a portion or all of the dynamic range of the medium. Illuminative treatment includes illuminative curing and/or illuminative erasing.

For the purposes of the present invention, “illuminative curing” refers to illuminative treatment with a curing beam that causes pre-curing or post-curing of all or a portion of a holographic storage medium.

For the purposes of the present invention, the term “pre-curing” refers to curing (e.g., illuminative curing) of a portion or all of an uncured holographic storage medium with a curing beam to increase the ability of the pre-cured portion or portions of the medium to stably write holograms.

For the purposes of the present invention, the term “pre-cured medium” refers to a holographic storage medium (or portion thereof) that has been subjected to pre-curing with a curing beam.

For the purpose of the present invention, the term “pre-cure exposure time limit” refers to the time after pre-curing is carried out when the benefits of pre-curing have degraded to the point of being of minimal or no useful value for writing holograms to the pre-cured spot(s) of the holographic storage medium. The mechanism behind these pre-cure benefits degrading over time is believed to be due to the photoinitiator component bonding with oxygen molecules until the amount of active photoinitiator component diminishes to the point that it is no longer useable.

For the purpose of the present invention, the terms “pre-cure active recording period” refers to the period of time after pre-curing and prior to the pre-cure exposure time limit.

For the purpose of the present invention, the term “generally wave-like pattern” refers to pre-curing in a manner that simulates an advancing wave.

For the purpose of the present invention, the term “pre-cure wave boundary” refers to the outer circumference, perimeter, portion, etc., of a pre-cure area which is created, formed, provided, etc., by pre-curing using a generally wave-like pattern.

For the purpose of the present invention, the term “pre-cure wave boundary area” refers to the area within the pre-cure wave boundary.

For the purposes of the present invention, the term “contiguous or nearly contiguous tiled geometry” refers to discrete locations in a holographic storage medium where the holographic storage medium has been subjected to curing (e.g., illuminative curing) treatment, where such locations may or may not overlap in whole or in part and which may leave small portions of the holographic storage medium unexposed to curing (e.g. illuminative curing) treatment. A holographic storage medium, or portion thereof, may be subjected to a curing (e.g., illuminative curing) treatment with a contiguous or nearly contiguous tiled geometry which has more than about 90% of the portion exposed to curing (e.g., illuminative curing) treatment.

For the purposes of the present invention, the term “uncured holographic storage medium” refers to a holographic storage medium (or portion thereof) that has not been subjected to treatment with a curing beam, e.g., pre-curing or post-curing.

For the purposes of the present invention, the term “increase the ability of the holographic storage medium to stably write holograms” refers to the ability to not only write holograms, but also to write holograms without the holograms degrading, disappearing, dissipating, etc., over time, i.e., form stable holograms. Increasing the ability to write stable holograms may also include imparting to the pre-cured portion of the holographic storage medium a relatively advantageous media response behavior in writing holograms.

For the purposes of the present invention, the term “media response” refers to the relative ability of the holographic storage medium to write holograms having equal or nearly equal diffraction efficiencies in the same volume of the medium as a function of exposure time to recording light.

For the purposes of the present invention, the term “media response curve” refers to a graphical plot of the media response as a function of required exposure time to recording light versus the number of holograms written.

For the purposes of the present invention, the term “disadvantageous media response behavior” refers to a media response where the holographic storage medium is unable to write stable holograms, or where the holographic storage medium is able to write stable holograms having equal or nearly equal diffraction efficiencies only by using greatly increased exposure times (representing slower data transfer rates for the holographic storage system) or by using exposure times which vary significantly (e.g., by a factor of greater than about 4 depending upon the desired data transfer characteristics of the holographic storage system) relative to exposure times of the majority of holograms written in the same or similar sequence in the same volume of the medium.

For the purposes of the present invention, the term “disadvantageous response region” refers to that region or regions of the media response curve where a holographic storage medium exhibits a disadvantageous media response behavior.

For the purposes of the present invention, the term “relatively advantageous media response behavior” refers to a media response where the holographic storage medium is able to write stable holograms having equal or nearly equal diffraction efficiencies using relatively modest or fast exposure times (e.g., providing relatively reasonable or fast data transfer rates for the holographic storage system) which have relatively low variability (e.g., vary by a factor of about 4 or less) relative to exposure times of the majority of holograms written in the same or similar sequence in the same volume of the medium.

For the purposes of the present invention, the term “relatively advantageous response region” refers to that region of the media response curve where a holographic storage medium exhibits a relatively advantageous media response behavior.

For the purposes of the present invention, the term “post-curing” refers to curing (e.g., illuminative curing) of a holographic storage medium with a curing beam that minimizes, removes, reduces, diminishes, etc., some or all of the residual sensitivity from a portion or all of the dynamic range of the medium to subsequent exposure to a light source, e.g. a recording or photoinitiating source. This residual sensitivity may cause accidental, inadvertent, unintentional, etc., holograms (e.g. noise holograms) to form due to, for example, self-interference of coherent light beams used for written holograms, that may obscure holograms, impair the ability to decode reconstructed holograms, etc. and is thus undesired.

For the purposes of the present invention, the term “post-cured medium” refers to a holographic storage medium that has been subjected to post-curing.

For the purposes of the present invention, the term “illuminative erasing” refers to illuminative treatment with an erasing beam that causes partial or complete removal of written holograms from all or a portion of the medium.

For the purposes of the present invention, the term “erased medium” refers to a holographic storage medium that has been subjected to illuminative erasing.

For the purposes of the present invention, the term “transmission” refers to transmission of a light beam from one component, element, article, etc., to another component, element, article, etc.

For the purposes of the present invention, the term “coherence” refers to one or more light beams, which, when combined, form a static distribution of constructive and destructive interference fringes. Coherence may include spatial coherence or temporal coherence.

For the purposes of the present invention, the term “coherence reduction” refers to where the coherence properties of a light beam have been reduced, minimized, lowered, moderated, diminished, eliminated, etc., to reduce, minimize, lower, moderate, diminish, eliminate, etc., interference fringes or where these effects are mitigated, such as, for example, translating interference fringes across a surface or volume so that the cumulative energy input over some period of time is approximately uniform.

For the purposes of the present invention, the term “diffuser” refers to a device which has the ability to scatter light in a controlled manner, fashion, etc., so as to evenly or more evenly distribute the light and thus reduce the spatial coherence of an illuminative treatment beam. A diffuser may additionally reduce temporal coherence effects of the illuminative treatment beam by having motion imparted to the diffuser.

For the purposes of the present invention, the term “motion” with reference to the motion imparted to the diffuser may refer to linear motion (e.g., one dimensional linear translation), rotational motion (e.g., in an arc, circle, oval, etc.), oscillating (e.g., back and forth linear or rotational motion), etc., that may be continuous, may include pauses, may be at regular or periodic intervals, etc., or any combination thereof. The amount of motion imparted may depend on the particular diffuser used, the coherence reduction effects to be created by the diffuser, etc.

For the purposes of the present invention, the term “shaping” refers to forming or otherwise shaping the illuminative treatment beam so that only a selected portion, area, etc., of the holographic storage medium having, for example, a predetermined geometry, is subjected to illuminative treatment.

For the purposes of the present invention, the term “lenslet” refers to an optical device comprising a plurality of shaped lens arrayed, organized, arranged, structured, ordered, etc., to operate as a unitary optical device. Each of the individual lenses of the lenslet may be designed to have a specific size, shape, curvature, etc., to achieve the combined effect or effects desired for the lenslet. The individual lenses of the lenslet may be stamped or otherwise formed from a single optical element.

For the purposes of the present invention, the term “multi-pass curing” refers to where the same curing beam, or portion thereof, passes through a holographic storage medium two or more times during illuminative curing, e.g., pre-curing or post-curing.

For the purposes of the present invention, the term “substantially linear translation” refers to movement of the medium substantially along a linear axis.

For the purposes of the present invention, the term “continuous, unidirectional rotation” with regard to movement of the holographic storage medium refers to smooth rotation of the medium in one direction about a rotational axis perpendicular to the plane of the medium without halting rotation periodically or intermittently.

For the purposes of the present invention, the term “row” refers to a plurality of arranged addresses. For disk-shaped holographic storage medium, the circular-shaped concentric rows are referred to hereafter as “tracks.” For rectangular-shaped holographic storage medium, “rows” are used to define the x-coordinate of each address, while “columns” are used to define the y-coordinate of each address. A row or track may represent all cure sites/cure spots (“cure track”), or all stacks of holograms which are written or to be written (“data track”), at the same radial distance from the center of the holographic storage medium (e.g., from the center of a holographic circular-shaped disk).

For the purposes of the present invention, the term “address” refers to a specific location in a row (track) and/or column.

For the purpose of the present invention, the terms “neighboring track” or “neighboring row” refer to a track or row which is adjacent to another track or row.

For the purposes of the present invention, the terms “stack” or “book” (collectively and interchangeably referred to hereafter as “stack”) refer to a group of multiplexed holograms that span a particular angular range and which are written in the same, or nearly the same, physical location on a holographic storage medium. A stack of multiplexed holograms may all be in one location in the holographic storage medium, or may be slightly shifted from one another or shifted from another stack/book of holograms. The term stack refers to both traditional stacks and books and composite books. Stacks may be located using tracks, and addresses within tracks, for circular-shaped disk media, and x-coordinate (row) and y-coordinate (column) addresses for rectangular-shaped media.

For the purposes of the present invention, the term “short stack” refers to sub-group of holograms within the address range of a stack. For example, a stack may be considered as a set of addresses that contain angles 1-500. This angular range may be further separated into “short stacks” so that short stack #1 contains angles 1-100, short stack #2 contains angles 101-200, etc.

For the purposes of the present invention, the term “composite book” refers interchangeably to a stack where at least some of the short stacks of the stack do not occupy the same spatial location. In fact, it may be useful to “smear” out any optically induced distortions by placing short stacks in different spatial locations. In a composite/book, the spatial locations of the short stacks may partially overlap one another, but differ enough spatially to mitigate any non-ideal media buildup due to multiple holograms being written in the same location.

For the purpose of the present invention, the term “stack position” refers to a position where a stack of holograms may be written to the recordable section of the holographic storage medium. In embodiments of the method of the present invention, the stack positions may be determined before the writing of the stacks of holograms to the recordable portion of the holographic storage medium.

For the purpose of the present invention, the term “order of the stacks” refers to the particular sequence in which the stacks of holograms are written to the recordable section of the holographic storage medium.

For the purpose of the present invention, the term “written stack” refers to a stack of holograms which have been written to the recordable section of the holographic storage medium.

For the purposes of the present invention, the term “stack spot” refers to a written stack on the recordable section of the holographic storage medium. A stack spot may also refer to the position at which the stack is written.

For the purpose of the present invention, the term “intensity profile” refers to the intensity or energy imparted by pre-curing to a pre-cured spot.

For the purpose of the present invention, the term “constant intensity pre-curing” refers to pre-curing which is carried out such that the intensity or energy imparted by pre-curing to a cure spot, as well neighboring cure spots, is the same or similar such that measurable distortion of the holograms written to the pre-cured spot(s) is minimized or avoided due to shrinkage of the holographic storage medium during subsequent post-curing. One embodiment for carrying out constant intensity pre-curing is by tiling of pre-cured spots.

For the purpose of the present invention, the term “constant intensity profile” refers to a cure spot, as well neighboring cure spots, which have subjected to constant intensity pre-curing, i.e., such that the intensity profile of the pre-cured cure spot and neighboring cure spots is the same or similar.

For the purpose of the present invention, the term “cure site” refers to an identifiable location (e.g., may be identified by track and address on a circular-shaped holographic storage disk, or by row and column on a rectangular-shaped holographic storage medium) on a recordable section of the holographic storage medium which corresponds a subsequently formed cure spot. While the location of the cure sites on the recordable section of the holographic storage medium may be shown as being physically present in the drawings for illustrative purposes, the location of each cure site on the medium may be simply defined, identified, kept track of, etc., electronically, for example, by using computer software, and may also be used to define, identify, keep track of, etc., the subsequently formed cure spot. For convenience in some embodiments, a cure site may correspond to the center of the subsequently formed cure spot. For convenience in some embodiments, and as shown, for example, in FIG. 1, a multiplicity of cure sites may be determined and arranged for the entire recordable section of the holographic storage medium for determining the desired or optimum layout of the subsequently formed cure spots, for determining the location of bookcases comprising the cure sites/cure spots on the recordable section of the holographic storage medium, for arranging, for example, in the case of circular-shaped disk, the cure sites/cure spots into a plurality of concentric tracks each comprising a plurality of such cure sites/cure spots, etc.

For the purpose of the present invention, the terms “layout” and “format” (collectively and interchangeably referred to hereafter as “layout”) refer to one or more of the arrangement and/or positioning of cure sites, corresponding cure spots, or stack positions on the recordable section of the holographic storage medium. The pre-curing sequence for the cure sites/cure spots and/or writing sequence for the stacks of holograms may also be defined by the layout.

For the purpose of the present invention, the term “cure spot” refers to a discrete portion of the recordable section of the holographic storage medium which corresponds to and encompasses one cure site and which has been pre-cured, or which has been post-cured after stacks of holograms have been written to the pre-cured spot(s). For some embodiments of a pre-cured spot, the intensity profile of the cure spot may have a central plateau of constant intensity, which then tails away or decreases at each edge of the plateau to an intensity (energy) of 0 at each end of the intensity profile of the pre-cured spot.

For the purpose of the present invention, the term “tiling of pre-cured spots” refers to pre-curing of cure spots such that neighboring cure spots which are pre-cured partially overlap. Tiling of pre-cured spots may occur across the entire recordable medium, or only across a portion of portion of the recordable medium, may occur within a row of cure sites and corresponding cure spots, may occur between cure sites/cure spots in different but neighboring rows, or any combination thereof. A purpose for tiling of pre-cured spots in some embodiments is to achieve a constant intensity profile across the pre-cured area comprising all neighboring pre-cured spots.

For the purpose of the present invention, the term “pre-cure neighboring cure spot rule” refers to a routine wherein a cure spot and all neighboring cure spots are pre-cured before the writing any stacks of holograms to the cure spot.

For the purposes of the present invention, the term “a pre-curing and stack writing routine” refers to a process wherein the pre-curing and stack writing steps are carried out in manner which follows the pre-cure neighboring cure spot rule. In a pre-curing and stack writing routine, as long as the pre-cure neighboring cure spot rule is followed, the sequence of pre-curing and stack writing steps may be carried out in any order, for example: pre-curing all of the cure spots to be written to, followed by writing stacks of holograms to all pre-cured spots; pre-curing some of the cure spots to be written to, followed by writing stacks of holograms to some of the pre-cured spots, followed by additional pre-curing of other neighboring cure spots, followed by additional writing of holograms to some or all of the pre-cured spots (either those first pre-cured and/or the other spots pre-cured), following by additional pre-curing of additional neighboring cure spots, etc.

For the purpose of the present invention, the term “runaway pre-cure process” refers to a phenomena which may occur in following the pre-cure neighboring cure spot rule where more pre-cured spots are formed than stacks of holograms can be written to within a pre-cure active recording period.

For the purposes of the present invention, the term and “pre-cure leakage” refers to phenomena where pre-curing unintentionally occurs or “leaks” into a neighboring uncured area of the holographic storage medium.

For the purpose of the present invention, the term “boundary” refers to a border where neighboring tracks/rows come together, meet, join, converge, etc., and having a width. Boundaries need to be wide enough that the cure spot closest to where the tracks/rows come together, meet, join, converge, etc., does not affect a neighboring cure spot(s) across the boundary. (By “affect a neighboring cure spot” is meant that some of the neighboring light from pre-curing light leaks onto the portion of the medium that is uncured, and thus at least partially pre-cures that portion of the medium, which may cause some loss of the dynamic range.) In some embodiments, the boundary may have a width in the range of from about 0.8 to about 1.8 mm (which may include any spacing between the neighboring tracks/rows).

For the purpose of the present invention, the term “radial boundary” refers to a boundary between neighboring cure sites/cure spots in the same track/row.

For the purpose of the present invention, the term “pre-cure boundary” refers to a boundary between neighboring pre-cure areas. One or more pre-cure boundaries may be used in embodiments of the method of the present invention. In some embodiments of the present invention using a disk-shaped holographic storage medium, one radial pre-cure boundary may be used which is positioned at or near the radial midpoint of the recordable section of the holographic storage medium. For example, in one such embodiment, the radial pre-cure boundary may be positioned such that at least about 55% of the tracks are positioned on the disk outside of the radial pre-cure boundary, and no more than 45% of the tracks are positioned on the disk inside this boundary, (e.g., 25 tracks on the disk are outside of the boundary and 20 tracks on the disk are inside of the boundary). The number of pre-cure boundaries used may be varied for different layouts used with the holographic storage medium.

For the purpose of the present invention, the term “bounded pre-cure area” refers to an area within the recordable section of the holographic storage medium between one or more pre-cure boundaries. The number of bounded pre-cure areas created, formed, etc., by the pre-cure boundaries may be as few as two, or may upwards of twenty or more. For example, in some embodiments of smaller capacity holographic storage media, there may be up to as many as twenty bounded pre-cure areas.

For the purpose of the present invention, the term “boundary pre-cure control rule” refers to the positioning of one or more pre-cure boundaries on the recordable section of the holographic storage medium to prevent or minimize a potential “runaway pre-cure process.”

For the purpose of the present invention, the terms “stack crossing” and “stack straddling” (collectively and interchangeably referred to hereafter as “stack straddling”) refer to a situation where a stack of holograms is written such that it crosses or touches more than one neighboring cure spot.

For the purpose of the present invention, the term “neighboring cure spot” refers to a cure spot which is adjacent to another cure spot which may be within the same track or row and/or which may be within an adjacent (neighboring) track or row.

For the purpose of the present invention, the term “bookcase” represents a grouping of one or more cure sites/cure spots which may be used to define the sequence in which the one or more stacks of holograms are to be written to holographic storage medium, and may represent a contiguous grouping of two or more neighboring cure sites/cure spots. Each bookcase may define a region or area of the recordable section of the holographic storage medium which may be completely written with stacks of holograms before stacks of holograms are written to another bookcase. Bookcases may also represent the maximum number of stacks of holograms which may be potentially written within each respective pre-cure active recording period. For convenience in some embodiments, after the entire recordable section of the holographic storage medium is divided into a multiplicity of positioned and/or arranged cure sites/cure spots, these cure sites/cure spots may then be grouped into a plurality of bookcases as shown in, for example, FIG. 8. Bookcases may also comprise the same number of cure sites/cure spots, or may comprise a differing number of cure sites/cure spots.

For the purpose of the present invention, the term “opened bookcase” refers to a bookcase which comprises at least one cure spot which has been pre-cured.

For the purpose of the present invention, the term “current bookcase” refers to a bookcase to which stacks of holograms are currently being written to.

For the purpose of the present invention, the term “finished bookcase” refers to a bookcase wherein all stacks of holograms which will be written to the bookcase have been written. A finished bookcase may also be partially or completely post-cured.

For the purpose of the present invention, the term “neighboring bookcase” refers to a bookcase which is adjacent to another bookcase.

For the purpose of the present invention, the term “device” may refer to an apparatus, a mechanism, equipment, machine, etc.

For the purpose of the present invention, the term “servo mark” refers to a mark, pattern, etc., put on the media so as to allow or enable the media or system to be aligned accurately with respect to each other. Servo marks may also be used to align media to other media. For example, the layout of the holographic storage medium may be indirectly aligned to the servo marks the same way each time to provide a fixed coordinate system that is the same or consistent from medium to medium. Methods other than servo may also be used to define the coordinate system of the media.

For the purposes of the present invention, the term “X-Y plane” typically refers to the plane defined by the substrates or the holographic storage medium that encompasses the X and Y linear directions or dimensions. The X and Y linear directions or dimensions are typically referred to herein, respectively, as the dimensions known as length (i.e., the X-dimension) and width (i.e., the Y-dimension).

For the purposes of the present invention, the terms “Z-direction” and “Z-dimension” refer interchangeably to the linear dimension or direction perpendicular to the X-Y plane, and is typically referred to herein as the linear dimension known as thickness.

### Description of Layout Method and Pre-Curing and Stack Writing Routines for Multiplexed Holograms

While writing single stacks of holograms have been explored in a variety of forums, efficient methods for tiling the stacks across the holographic storage medium still need to be considered. The problem of tiling stacks efficiently across, for example, a flat disk or coupon of a holographic storage medium may be compounded by timing issues due to the chemistry of the medium itself, the need to pre-cure and post-cure the areas of the medium that are going to be written on, the soft edges of the light beam used to pre-cure and/or post-cure the medium, etc. For example, the photopolymers present in the holographic storage medium that stores the holograms may require a brief exposure to light before the holograms are written. This brief exposure, referred to herein as a “pre-cure,” may be used to ready the photoinitiator component in the medium so that this photoinitiator component may react properly when the holograms are actually written to the medium. After the pre-cure exposure, the medium may tend to slowly lose its readiness, and potentially rendering it unusable for writing holograms within a short period of time, for example, within from about 10 to about 20 minutes (i.e., each pre-cure active recording period is in the range of from about 10 to about 20 minutes).

To achieve adequate or optimum data transfer rates, it may be logical to pre-cure as large an area of the holographic storage medium as possible. For example, it may be faster to pre-cure large areas of the holographic storage medium at the same time so that the servo system does not have to cause large movements or shifts of the medium, which might be required when moving the medium from a writing location to a curing location multiple times. Pre-curing many sites within this large area in parallel may also reduce the amount of total pre-cure time, thus allowing writing and filling of as much of pre-cured area as possible with holograms prior to this “pre-cure exposure” losing its effectiveness, and before moving on to another area or portion of the holographic storage medium for writing and storing additional holograms. But it may be difficult to ensure that the pre-cure in one of these areas does not leak into a neighboring uncured area. For example, this pre-cure leakage may occur due to the non-sharp edges of an incoherent cure beam used in pre-curing. The pre-cured areas may be written a short distance apart to avoid or minimize leakage into neighboring uncured areas, but at the expense of decreasing total data storage capacity of the holographic storage medium.

In embodiments of the method of the present invention, the layout of the holographic storage medium (e.g., disk-shaped media) may defined by the position of the pre-cure (and potentially post-cure spots), rather than by the stacks of holograms written to the medium. Initially, pre-cure sites may be chosen for tiling pre-cured spots across the entire recordable section of the disk as efficiently as possible. Tiling the pre-cured spots provides for a constant intensity profile of the pre-cured spots across the recordable section of the disk to keep the holograms from distorting due to media shrinkage during the post-cure process. In fact, providing a constant intensity profile in the area of the pre-cured spots allows for the writing of stacks of holograms within this area in any order. Instead, the order of writing the stacks may be determined by minimizing deformation of the media during the writing process. After pre-curing the cure spots, stacks of holograms may then be written within the area comprising the pre-cured spots as densely as necessary to achieve the desired capacity.

Once the cure sites/cure spots and stack positions have been determined for the recordable section of the disk, the cure sites/cure spots may then be grouped into bookcases. Each bookcase may define an area on the disk that will be completely written with one or more stacks of holograms before writing any other stacks of holograms to another bookcase. If one stack of holograms is written within the bookcase is started, the entire bookcase needs to be completely written (filled) with stacks of holograms within the pre-cure active recording period, or recordable section of the bookcase may be unusable, thus decreasing the potential amount of writable space on the disk.

To avoid potential stack straddling where stacks of holograms touch or cross a pre-cured spot and at least one cure spot which has not been pre-cured, all neighboring cure spots are pre-cured. This is a simple example of the operation of the “pre-cure neighboring cure spot rule.” In writing all stacks of holograms to a particular bookcase within the pre-cure active recording period before writing any holograms to another bookcase, additional pre-curing may be required to satisfy the “pre-cure neighboring cure spot rule” to avoid stacks of holograms being written which might straddle pre-cured spots and areas of the medium which have not yet been pre-cured. Unfortunately, once a cure spot within a neighboring bookcase is pre-cured, thus creating an “opened bookcase,” it may become necessary to not only finish writing all stacks of holograms to the current bookcase, but to then write stacks of holograms to this neighboring “opened” bookcase within the new pre-cure active recording period created by the pre-curing within the opened bookcase. To comply with the “pre-cure neighboring cure spot rule,” further pre-curing of neighboring cure spots may be required in to avoid undesired stack straddling of neighboring cure spots, wherein some of which have been pre-cured and some of which have not been pre-cured, but which may then cause the “opening” of yet another neighboring bookcase or bookcases. Accordingly, strictly following the “pre-cure neighboring cure spot rule” may cause the sequential “opening” of neighboring bookcases in an accelerating pattern which may create more pre-cured area than may be written to with stacks of holograms within the applicable and/or latest pre-cure active recording period, than might otherwise have been written to if these neighboring bookcases had not been prematurely “opened” to follow the “pre-cure neighboring cure spot rule.” This phenomena which may occur from strictly following the “pre-cure neighboring cure spot rule” is what is referred to as a “runaway pre-cure process”.

To avoid or minimize the problem a “runaway pre-cure process,” embodiments of the method of the present invention further impose an additional rule known as the “boundary pre-cure control rule.” The “boundary pre-cure control rule” operates by determining and/or positioning a pre-cure boundary (in which stacks of holograms are not written) on the recordable section of the holographic storage medium which thus creates two or more bounded pre-cure areas. In other words, the “boundary pre-cure control rule” prevents pre-curing of cure spots across the pre-cure boundary and into the neighboring bounded pre-cure areas, thus preventing or at least minimizing the potential for a “runaway pre-cure process” problem from happening. While following the “boundary pre-cure control rule” may reduce somewhat the total recordable area of the holographic storage medium, only a minimal capacity loss may occur for every such pre-cure boundary created. In fact, in some embodiments of the method of the present invention, only one such pre-cure boundary may need to be created to prevent or minimize “runaway pre-cure process” problems.

In some embodiments, these bounded pre-cure areas may encompass only as many bookcases as stacks of holograms may be written to (up to the theoretical maximum number of stacks of holograms which may be potentially written to the particular medium) within the appropriate and/or latest pre-cure active recording period(s). In other embodiments, not every cure site/cure spot within the bounded pre-cure area may be pre-cured at the same time, so it may be possible to pre-cure areas larger than the limit imposed by the pre-cure active recording period. For example, pre-curing may be carried out by using a generally wave-like” pattern to spread the pre-cured spots across the holographic storage medium. For example, when pre-curing using a generally wave-like pattern with holographic storage medium which is a circular-shaped disk) the pre-cure and stack writing routine starts at a cure site/cure spot (e.g. a cure site/cure spot in the inner most track, outer most track, etc.) on the recordable section of the disk and then progresses radially and outwardly therefrom in a generally wave-like pattern, thus creating a pre-cure wave boundary which has an expanding circumference as pre-curing progresses. The circumference of this pre-cure wave boundary may be relatively small at first, thus making it easier to pre-cure and write stacks holograms to the cure spots before the pre-cure active recording period expires. But as pre-curing continues, the circumference of this pre-cure wave boundary gets progressively larger and larger as it moves away from the starting cure site/cure spot, thus enabling a “runaway pre-cure process” to begin and then accelerate until it may become physically/mechanically impossible to write stacks of holograms fast enough to fill the cure spots which have been pre-cured before the appropriate and/or latest pre-cure active recording period(s) expires.

Imposing/establishing pre-cure boundaries (according to the boundary pre-cure control rule) serves as a way to guide and channel this pre-cure wave boundary so that the circumference of this wave boundary does not grow too large a size so as to create a “runaway pre-cure process.” By imposing/establishing such pre-cure boundaries, the pre-cure wave boundary is unable to expand across the imposed/established boundary, which thus effectively limits the size of (e.g. circumference) of the pre-cure wave boundary so that stack writing of the pre-cured spots may be carried before the appropriate and/or latest pre-cure active recording period(s) expires. If designed efficiently, the active (writable) portion of the pre-cure area within the pre-cure wave boundary (“pre-cure wave boundary area”) for stack writing remains the same or similar in size up until almost the end of the stack writing to this pre-cure area. This means the real size constraint on this pre-cure area within the pre-cure wave boundary is determined by the width of this pre-cure area. In other words, this pre-cure area needs to be of a size (e.g., narrow enough) so that all of the stacks of holograms may be written radially across this pre-cure area before the appropriate and/or latest pre-cure active recording period(s) expires. Because the pre-cure boundaries may be concentric in shape (e.g., to follow the concentric shape of the neighboring tracks between which such boundaries may be imposed), the pre-cure wave boundary may be guided or channeled to move around the recordable portion of the disk somewhat like the hands of a clock sweeping out the area before them.

Embodiments of the method of the present invention may be used to achieve a high transfer rate and data storage capacity, while at the same time avoiding or minimizing problems such as a “runaway pre-cure process” or “pre-cure leakage,” etc. Embodiments of the method of the present invention may also be used to densely populate the recordable section of a holographic storage medium with as many stacks of holograms, up to the maximum number holograms potentially writable to the medium, and relatively quickly. Embodiments of the method of the present invention may also be designed to be flexible to allow for changes in the layout of future holographic storage media. Embodiments of the method of the present invention may also be used to efficiently write many multiplexed stacks of holograms on a single piece of media. Embodiments of the method of the present invention allow for even pre-curing of the recordable section of the holographic storage medium to a constant intensity profile so that as much of the recordable section may be written to with stacks of holograms.

One embodiment of a layout method according to the present invention, the positions of all of the cure sites/cure spots are determined (e.g., selected, chosen, etc.) so that the intensity (energy) profile of the cure spots after pre-curing is constant across the entire recordable section of the holographic storage medium, or at least that portion or portions of the recordable section to which stacks of holograms are to be written. The positions of all of the stacks of holograms to be written to at least one of the cure spots to be pre-cured are also determined (e.g., selected, chosen, etc.). Determination of the positioning of the cure sites/cure spots and stacks of holograms are interchangeable (i.e., may be carried out sequentially or concurrently and in any order) because the positions of the stacks and cure spots are independent of each other. After determining the positions of the cure sites/cure spots and stacks of holograms, the cure spot(s) to which each of the stacks of holograms is to be written to may then determined be determined (e.g., selected, chosen, etc.) After determining which cure spot(s) each of the stacks of holograms is to be written to, the cure spots may then be grouped into each of a plurality of bookcases, by, for example, one bookcase at a time, manually, entirely by an algorithm which tries to evenly choose and allocated the bookcases which may be used, etc.

In another embodiment of a layout method according to the present invention, the positions the cure sites/cure spots to be grouped into each of a plurality of bookcases to be positioned on a recordable section of a holographic storage medium, or at least that portion or portions of the recordable section to which stacks of holograms are to be written to, are determined (e.g., selected, chosen, etc.). After grouping cure sites/cure spots to bookcases, each stack of holograms (from all stacks to be written to the recordable section) is assigned to one of the bookcases. After assigning each stack of holograms to a bookcase, the position of each bookcase on the recordable section of the holographic storage medium, or portion(s) thereof, is then determined (e.g. selected, chosen, etc.) based on the position of the cure site for each cure spot within each bookcase.

After determining the layout of the recordable section of the holographic storage medium, the cure spots may be pre-cured and stacks of holograms written by using a method comprising one or more pre-curing and stack writing routines. One embodiment according to the present invention of such a method involves, for each bookcase to be written to a first pre-curing and stack writing routine which comprises the steps of: (1) pre-curing a first cure spot within a first row and within the bookcase; (2) pre-curing all cure spots neighboring the first cure spot and which are not within a different bounded pre-cure area so as to provide a first pre-cured area having a constant intensity profile; and (3) writing one or more stacks of holograms to the first cure spot within the first row. After each bookcase reaches the point where a stack of holograms is to be written to a second cure spot which has been pre-cured within the bookcase, a second pre-curing and stack writing routine may be carried out which comprises the steps of: (1) pre-curing all cure spots neighboring the second cure spot which have not been pre-cured and which are not within a different bounded pre-cure area so as to provide a second pre-cured area having a constant intensity profile; and (2) writing one or more stacks of holograms to the second cure spot. The first and second pre-curing and stack writing routines may then be carried out until all stacks of holograms to written are written to the bookcases.

In an embodiment of a method embodiment according to the present invention, and when neighboring cure spots have been completely written with all stacks of holograms to be written to those neighboring cure spots, these one or more of these neighboring cure spots may be post-cured. As long as neighboring cure spots have been completely written to, this post-curing step of these neighboring cure spots may be carried out at any time, and in any sequence or order. In some embodiments of such post-curing, the firmware and/or software controlling the pre-curing, and especially writing of stacks of holograms, may wait until there is a break or pause in the data stream before post-curing cure spots which have been completely written to. In another embodiment of this post-curing step, a time limit (e.g., about 20 minutes) may be imposed to force the firmware and/or software to start and/or continue post-curing of the these cure spots which have been completely written to minimize or avoid too large a backlog of such cure spots which are to be post-cured. This post-curing step may be repeated until all cure spots having written stacks are post-cured.

As previously described, in embodiments of the method of the present invention, the layout of the recordable section of the holographic storage medium may be defined by the positioning and/or arrangement of the cure spots, or may be defined by the positioning of the bookcases comprising those cure spots, separate and distinct from the stack positioning on the recordable section. An illustration of an embodiment of the layout method of the present invention involving, for example, a holographic storage disk (i.e., circular-shaped holographic storage medium) is shown in FIGS. 1 through 6, and is generally indicated as 100. Referring to FIG. 1, disk 100 may include a central portion, which is indicated generally as 104, having a hub 106, and generally annular outer perimeter or peripheral portion, which is indicated generally as 108. FIG. 1 further shows disk 100 as having an annular-shaped recordable section, which is indicated generally as 112, and which is positioned between central portion 104 and peripheral portion 108. A multiplicity of cure sites may be determined for recordable section 112 and may be arranged in a plurality of concentric tracks across recordable section 112 from central portion 104 outwardly to peripheral portion 108 to provide for efficient formation of subsequent cure spots by tiling thereof across the entirety of recordable section 112 and for efficient stack positioning for writing of stacks of holograms to recordable section. The combined cure site/cure spot positioning and arranging, as well as the stack positioning, comprises the “layout” of recordable section 112.

Two of concentric tracks are used in FIG. 1 to illustrate the arrangement of these cure sites/cure spots within each track and with respect to cure sites/cure spots in neighboring tracks, and are indicated generally as outermost track 116, and an inner track 120 adjacent to neighboring outermost row 116. Outer track 116 comprises a plurality of concentrically arranged cure sites/cure spots, of which three are identified as 116-1, 116-2 and 116-1. Inner track 120 also comprises a plurality of concentrically arranged cure sites/cure spots, of which one identified as 120-1 which is adjacent but offset relative to neighboring cure sites/cure spots 116-1 and 116-2, while three others are also shown and identified as cure sites/cure spots 120-10, 120-11 and 120-12. As further shown in FIG. 1, recordable section 112 comprises additional inner generally concentric tracks of cure sites/cure spots, which are generally identified as 124, 128, 132, 136, 140, and 144, and which progress inwardly and radially towards the inner most track, generally identified as 148, or conversely progress outwardly from inner most track 148 to outer most track 116.

As can also be seen in FIG. 1, at the beginning/end of each track, which indicated generally by arrow 152 and which is referred to hereafter as the “overlap boundary,” the cure spots may overlap slightly. Six such instances of overlapping cure spots are indicated as 152-1, 152-2, 152-3, 152-4, 152-5, and 152-6. While overlapping of cure spots such as 152-1, 152-2, 152-3, 152-4, 152-5, and 152-6 may be permitted, the overlapping of written stacks (hereafter referred to as “stack spots”) cannot overlap on recordable section 112. This may mean that the last cure spot at the end of each track may only comprise stack spots up to but not crossing overlap boundary 152.

As further shown in FIG. 1, neighboring cure sites/cure spots within the same track (such as 116-1 and 116-2), as well as neighboring cure sites/cure spots in neighboring tracks (such as such as 116-1 and 116-2 and 120-1) are overlapped (tiled). In fact, cure spots, such as 116-1, 116-2, 116-1, 120-1, 120-10, 120-11, and 120-12, in each of tracks 116 through 148 may be arranged so as to be tiled across the entire recordable section 112. In other words, all neighboring cure spots are at least partially overlapped or tiled across the entire recordable section 112. The purpose of such tiling or overlapping is to ensure a constant intensity profile is achieved not only at the center of each tiled cure spot during pre-curing, but also in the overlapping region of the tiled cure spots.

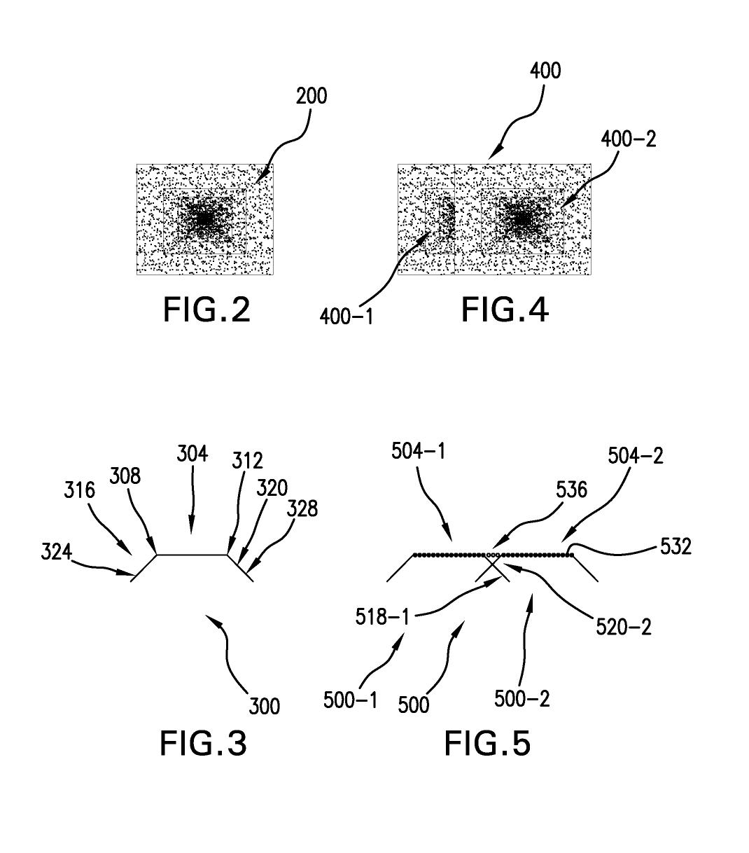

This tiling or overlapping to achieve a constant intensity profile during pre-curing is further illustrated in FIGS. 2 through 5. For illustrative purposes, each cure spot shown in FIGS. 2 through 5 (as well as FIG. 1) is considered to have a generally rectangular shape. FIG. 2 illustrates a top plan view of a single cure spot (such as 116-1) from recordable section 112 of disk 100, and is generally indicated as 200. A side view of the intensity profile of cure spot 200 of FIG. 2 is further illustrated in FIG. 3, and is generally indicated as 300. Intensity profile 300 comprises a central plateau region representing the maximum intensity (energy) of cure spot 200. As further shown in FIG. 3, the intensity of cure spot 200 fails away or decreases at each edge 308 and 312 of central plateau, as indicated by the adjacent beginning upward sloped region 316 and the adjacent ending downward sloped region 320, and reaches a minimum at beginning point 324 and the ending point 320.

Single cure spot 200, with the intensity profile 300, represents a full-width size (the “width” in this case being defined as across the respective track) at half-max (i.e., the intensity at the respective beginning point 324 and endpoint 328 of cure spot 200 each have about 50% of the energy of the central plateau region 304 of the cure spot) so as to provide a constant intensity profile across the neighboring cure spots, including the region of overlap between the cure spots. In other words, at the very edge of each cure spot rectangle (i.e., beginning point 324 and endpoint 328), there is up to about 50% of the pre-curing energy as is received in the central plateau region (i.e., 304) of the cure spot.

If two neighboring cure spots are tiled so to have slightly overlapping beginning and ending regions, then the total intensity (energy) in the overlapping beginning and ending regions will equal or almost equal the intensity (energy) of the central plateau region of each tiled cure spot. FIG. 4 illustrates a top plan view of such a pair of overlapping or tiled cure spots (such as 116-1 and 116-2) from recordable section 112 of disk 100, and is generally indicated as 400, with each respective cure spot being indicated, respectively as 400-1 and 400-2. The side view of the intensity profile of overlapping cure spots 400-1 and 400-2 of FIG. 4 is further illustrated in FIG. 5, and is generally indicated as 500, with the separate intensity profiles of each cure spot 400-1 and 400-2 being indicated, respectively, as 500-1 and 500-2. As shown in FIG. 5, each of cure spots 401-1 and 400-2 have a central plateau region of maximum energy (intensity), indicted, respectively as 504-1 and 504-2, with ending region 516-1 of cure spot 400-1 and beginning region 520-2 of cure spot 400-2 slightly overlapping within the region, indicated as 532. During the overlapping or tiling of regions (such as region 532), the cure spots (such as cure spots 400-1 and 400-2) may be tiled both in the tangential direction and in the radial direction, i.e., the full-width, half-max size previously referred to may be along and/or across the cure spot.

As indicated by the dotted intensity (energy) line 536, overlapping region 532 has the same or similar energy (intensity) as the central plateau regions 504-1 and 504-2, thus providing a constant intensity profile across the tiled cure spots 400-1 and 400-2. Put differently, if energy gradients represented by the slopes of beginning region 516-1 and ending region 520 are linear or essentially linear, then the energy (intensity) from central plateau 504-1 to overlapping region 532 to central plateau 504-2 will be essentially constant. Referring now to FIG. 1, the cure spot rectangles, such as 116-1 and 116-2, represent the 50% (or full-width, half-max) energy size of each cure spot. Accordingly, the 90% energy size of cure spots 400-1 and 400-2 is just slightly larger than the cure spot rectangles 116-1 or 116-2) represented in FIG. 1, while the 10% energy size is just a little smaller than these cure spot rectangles.

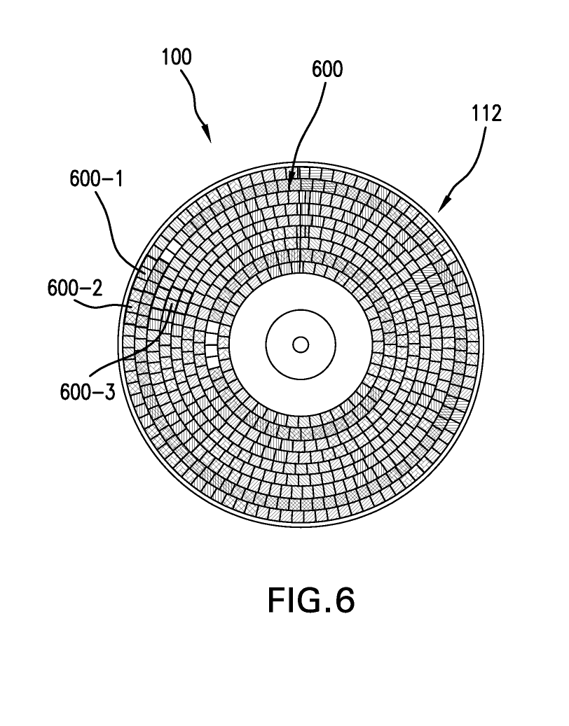

Once the layout of cure sites/cure spots (see, for example, FIG. 1), as well as the layout of stack positions, entire recordable section 112 is determined, the cure sites/cure spots of disk 100 may be grouped into regions or areas known as bookcases, the layout of which is indicated generally as 600 in FIG. 6. Three such neighboring bookcases are identified in FIG. 6 as 600-1, 600-2 and 600-3. As also illustrated in FIG. 6, bookcases 600-1, 600-2 and 600-3 are shown as comprising 6 cure sites/cure spots. The particular number of cure sites/cure spots for each bookcase may vary (e.g., at least some of the bookcases may have differing numbers from the remaining bookcases) or may be the same all of the bookcases, may include one or more rows or tracks, etc., and may often depend on the particular layout and size of recordable section 112, the number of stacks of holograms to be written to the recordable section 112, the pre-curing and stacking writing routine(s) to be used, the particular pre-cure active recording period(s) involved, etc. In some embodiments, bookcases may be used to assign particular stacks of holograms to be written to a specific bookcase, as well as to define the particular sequence in which these assigned stacks of holograms are to be written to recordable section 112. For example, bookcase 600-1 may be the first bookcase of layout 600 written to, followed by bookcase 600-2, etc. Also, in embodiments of the method of the present invention, bookcase 600-1 may be completely written to with stacks of holograms to provide a finished bookcase, before any stacks of holograms are written to another bookcase in recordable section 112, e.g., bookcase 600-2 to, for example, minimize loss of useable portions of recordable section 112 due to, for example, the particular pre-cure active recording period(s) involved. Again, the bookcases may be written to in any sequence or order, with the particular sequence or order in which bookcases are written to being determined, for example, by how many stacks of holograms need to be written to each bookcase, the particular pre-curing and stack writing routine(s) used, the size of recordable section 112, etc.

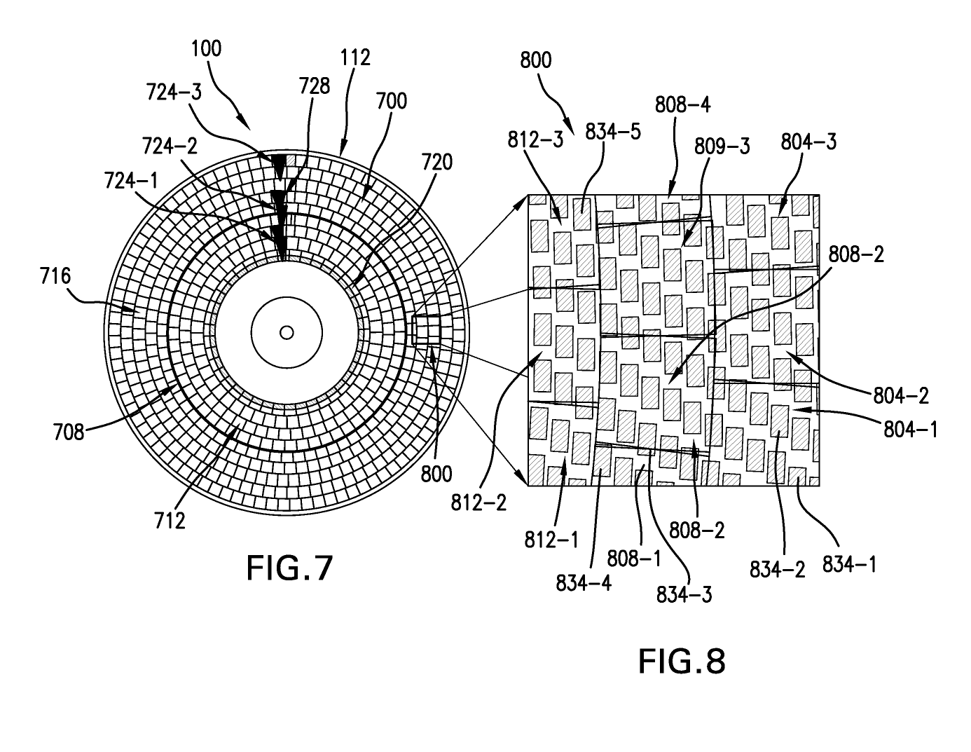

After the layout (including the layout of the bookcases) is determined for recordable section 112 (e.g., as illustrated in FIGS. 1 through 6), pre-curing and stack writing routines may be carried out to pre-cure, in the appropriate order, cure spots and to write (multiplex), in the appropriate order, stacks of holograms to the pre-cured spot(s) in each recordable portion (e.g., each bookcase) in recordable section 112. FIG. 7 illustrates disk 100 in which the recordable section 112 comprises an area, which is generally identified as 700, in which all cure spots have been pre-cured and post-cured, and in which stacks of holograms have been written to all but one portion of area 700. As further shown in FIG. 7, area 700 has a generally annular pre-cure boundary 708 imposed, established or positioned approximately at the radial midpoint of area 700 so as to divide area 700 into an inner bounded pre-cure area 712 and an outer bounded pre-cure area 716. The annular portion, indicated as 720, shown in FIG. 7 represents an area (for example, a concentric track) that was pre-cured and post-cured, but to which stacks of holograms have not been written. This unwritten area 720 may be caused by requiring an integer number of cure spot tracks for the purpose of pre-curing, but, because of physical/mechanical limitations in how far stacks of holograms may be written to this inner most portion of recordable section 112, no stacks of holograms are written thereto. For example, due to the positioning of cure beam delivery optics, areas closer to the center of disk 100 may be pre-cured, but no holograms may be writable to these pre-cured areas closer to the center of disk 100 due to these physical/mechanical limitations.

The three areas shown in FIG. 7, and indicated as 724-1, 724-2, and 724-3, represent and illustrate stacks of holograms which have accidentally been written to portions of recordable section 112 for which the appropriate pre-cure active recording period has expired. These stack spots 724-1, 724-2, and 724-3 are the result of the failure to follow the pre-cure neighboring cure spot rule (as described further below). This problem may be visualized by the pre-cure portion of the pre-curing/stack writing routine following a generally wave-like-pattern, with the first cure site/cure spot being opened at, say, the 12 o'clock position on peripheral portion 108. Neighboring cure sites/cure spots immediately to the right and left of this first cure site/cure spot also need to be pre-cured. But if the pre-cure neighboring cure spot rule is strictly followed, then the pre-cure wave front will proceed in both the clockwise and counter-clockwise directions around recordable section 112. This dual pre-cure wave boundary may be too much for physically/mechanically writing stacks to all of cure spots which have been pre-cured within the appropriate and/or latest pre-cure active recording period(s), and thus a “runaway pre-cure process” may ensue. To avoid such a “runaway pre-cure process,” a radial pre-cure boundary line, indicated as 728, may be imposed, established or positioned just to the left of the first cure site/cure spot. But because the circumference of each track requires different integer numbers of cure sites/cure spots, the cure sites/cure spots cannot precisely line up within a radial line or “spoke”. As a result, it may difficult or impossible from a practical standpoint to impose, establish or position a precise pre-cure boundary line (such as line 728) in recordable section 112 from central portion 104 outwardly towards peripheral portion 108. So, even when establishing a radial pre-cure boundary line to limit the direction of this dual pre-cure wave boundary, some cure spot edges may leak across this radial boundary line. As a result, the pre-cure neighboring cure spot rule (which is further discussed below) may not be followed in such cases to avoid a “runaway pre-cure process” (as further discussed below), and may thus result in some badly written and unreadable stacks of holograms. Alternatively, more space may be left between neighboring cure spots along this radial boundary, which may result in losing some capacity, but still allows the pre-cure neighboring cure spot rule to be followed.

The sequence or order of the writing the stacks of holograms to the cure spots which have been pre-cured may also be dictated by the need to minimize deformation of the media during the writing process, including shrinkage due to writing stacks to two polytopic layers to increase capacity. The order of writing the first layer and/or second layer may be selected to mitigate such shrinkage. For example, all of the first layer within a data track in a bookcase may be written to, and then the second layer of that same data track may be immediately written to before moving to the next data track. Sometimes, the first layer for all data tracks within the bookcase may be written to before writing to all data tracks within the second layer. Having to write to two polytopic layers to increase capacity while minimizing shrinkage thus makes the order or sequence of writing stacks that much more difficult to achieve. Accordingly, the tiling of cure spots affords degrees of freedom to mitigate the deformation due to writing stacks to two polytopic layers to use as much of the dynamic range of the medium as is possible or practical.

FIG. 8 represents square breakout area 800 from FIG. 7 which is in outer bounded pre-cure area 716 and illustrates the positioning and arrangement of the cure spots, as well as the positioning and arrangement of the stack spots (i.e., where stacks of holograms have been written to area 716). Breakout area 800 is shown as including three concentric and neighboring data tracks 804, 808 and 812 comprising cure-spots. Three cure spots 804-1, 804-2, and 804-3 are shown for data track 804, four cure spots 808-1, 808-2, 808-3, and 808-4 are shown for data track 808, and three cure spots 812-1, 812-2, and 812-3 are shown for data track 812. Also shown in FIG. 8 are a multiplicity of stack spots 834, of which six are identified as 834-1, 834-2, 834-3, 834-4, 834-5, and 834-6. Each of stack spots 834 (such as 834-1, 834-2, 834-3, 834-4, 834-5, and 834-6) comprise a stack of holograms written to, for example, cure spots 804-1, 804-2, 804-3, 808-1, 808-2, 808-3, 808-4, 812-1, 812-2, and 812-3. As can be seen in FIG. 8, cure spots in neighboring data tracks (e.g. data tracks 804 and 808) are offset such that, for example, cure spot 804-2 is positioned between cure spot 808-2 and 808-3. This offset of cure spots in neighboring tracks is due to the overlapping or tiling of cure spots so that there is a constant intensity profile for the pre-cure of these cure spots, thus providing the flexibility to write the stacks of holograms in any sequence or order. As further shown in FIG. 8, the stacks spots, such as 834-3 and 834-6, may cross or straddle cure boundaries, i.e., may touch two or more neighboring cure spots. This potential for stack spots 834 to cross/straddle cure spot boundaries is the reason for the use of the pre-cure neighboring cure spot rule to pre-cure neighboring cure spots and thus avoid stack spots which might straddle or touch a cure spot which has not been pre-cured, as is further described below.

While an entire bookcase (e.g., bookcase 600-1) may be completely written with stacks of holograms before moving on to write stacks of holograms to the next bookcase in the stack writing sequence or order, the pre-curing of cure spots often needs to occur in other than a sequential order to ensure that: (1) all neighboring cure spots have been pre-cured before potential stack straddling between neighboring cure spots occurs; and (2) pre-curing is even across the recordable section of the holographic storage medium to provide a constant intensity profile. As a result, before stacks of holograms are completely written to a given cure spot which is pre-cured, wherein some of the stacks of holograms to be written may straddle neighboring cure spots which have not yet been pre-cured, stack writing is halted or paused, and all of these neighboring cure spots which have yet to be pre-cured are then pre-cured, including any neighboring cure spots which may exist within other tracks/rows or even other bookcases according to the pre-cure neighboring cure spot rule.

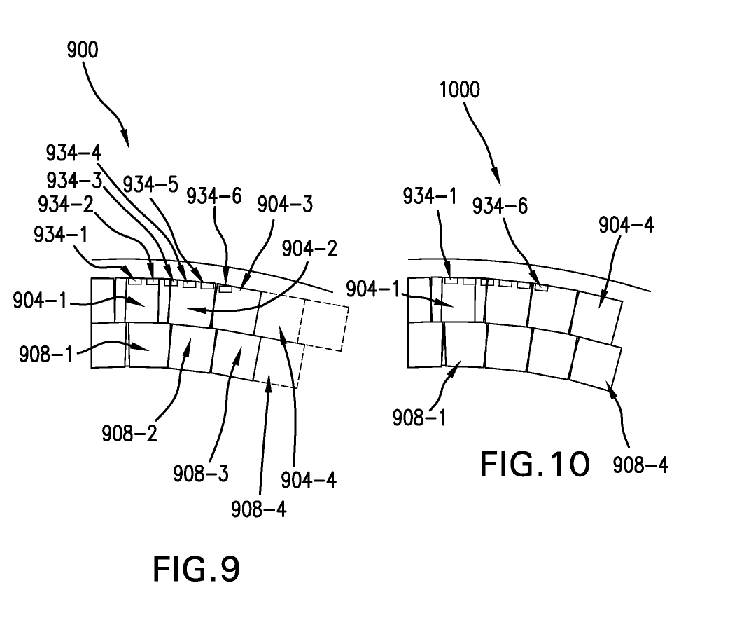

The operation of the pre-cure neighboring cure spot rule is further illustrated schematically by the diagrams shown in FIGS. 9 and 10. Diagram 900 of FIG. 9 illustrates schematically an embodiment of a first step of this pre-cure neighboring cure spot rule, while diagram 1000 of FIG. 10 illustrates schematically an embodiment of second sequential step of this rule. As illustrated in FIG. 9, two neighboring concentric tracks 904 and 903 are shown, with three cure spots for track 904 which have been pre-cured being identified as 904-1, 904-2, and 904-3, and with three cure spots for track 908 which have been pre-cured being identified as 908-1, 908-2, and 908-3. For the first step illustrated in FIG. 9, five stacks of holograms, identified as stack spots 934-1, 934-2, 934-3, 934-4, and 934-5, have been written to cure spots 904-1 and 904-2. The next stack of holograms, illustrated by dashed rectangle 934-6, is to be written to cure spot 904-3. Before writing stack 934-6 to cure spot 904-3, and following the pre-cure neighboring cure spot rule, cure spots, illustrated by dashed rectangles 904-4 and 904-8 in FIG. 9, which are neighboring to cure spot 904-3 need to be pre-cured. Accordingly, as illustrated by the embodiment of the second step of the pre-curing and stack writing routine shown in FIG. 10, cure spots 904-4 and 908-8, as represented by the solid line rectangles, have been pre-cured. As also shown in FIG. 10, after cure spots 904-4 and 908-8 have been pre-cured, stack 934-6, as represented by the solid line rectangle, is then written to cure spot 904-3.

### Description of Holographic Storage Media Generally

The formation of holograms using a holographic data storage system relies on a refractive index contrast (Δn) between light exposed and unexposed regions of a holographic storage medium, this contrast being at least partly due to polymerizable component (e.g., monomer/oligomer) diffusion to exposed regions. High index contrast may be desired because it provides improved diffraction efficiency when reconstructing, recovering or reading holograms. One way to provide high index contrast is to use a photoactive polymerizable component (e.g., photoactive monomer/oligomer) having moieties (referred to as index-contrasting moieties) that are substantially absent from the support matrix, and that exhibit a refractive index substantially different from the index exhibited by the bulk of the support matrix. For example, high contrast may be obtained by using a support matrix that contains primarily aliphatic or saturated alicyclic moieties with a low concentration of heavy atoms and conjugated double bonds (providing low index) and a photoactive monomer/oligomer made up primarily of aromatic or similar high-index moieties.

The holographic storage medium may be formed in any suitable manner from a combination, blend, mixture, etc., which may comprise a support matrix, polymerizable component, photoinitiator component, etc. which may also be associated with or positioned between a support structure, such as a pair of (i.e., two) substrates (e.g. glass plates, plastic plates, etc.). The polymerizable component includes at least one photoactive polymerizable material that can form holograms when exposed to a photoinitiating light source. The photoactive polymerizable materials may include any monomer, oligomer, etc., that is capable of undergoing photoinitiated polymerization, with or without a photoinitiator. Suitable photoactive polymerizable materials may include those which polymerize by a free-radical reaction, e.g. molecules containing ethylenic unsaturation such as acrylates, methacrylates, acrylamides, methacrylamides, styrene, substituted styrenes, vinyl naphthalene, substituted vinyl naphthalenes, other vinyl derivatives, etc. It may also be possible to use cationically polymerizable systems; a few examples are vinyl ethers, alkenyl ethers, allene ethers, ketene acetals, epoxides, etc. Furthermore, anionic polymerizable systems may also suitable herein. It is also possible for a single photoactive polymerizable molecule to contain more than one polymerizable functional group.

For holographic storage media from which holograms may be partially or completely erased, and which may optionally write new holograms on the erased portions, a photoreactive material which reversibly forms the holograms may be used. These photoreactive materials often create the holograms when exposed to photoinitiating light (e.g., recording light) having a first wavelength. To erase the written holograms, the written holograms may be exposed to light of a second different wavelength that is non-photorecording or non-photocuring (i.e., is an erasing beam) to breakdown the reacted photoreactive material, and to desirably regenerate the photoreactive materials. These regenerated photoreactive materials may then be subjected to recording light of the first wavelength to generate new holograms which written to the holographic storage medium. Suitable photoreactive materials may include those that create a reversibly stable cyclic ring structure such as a cyclobutane ring via a 2+2 or 4+4 photodimerization. Some examples of photoreactive materials which may create reversibly stable cyclic ring structures include anthracenes, acenaphtylenes, vinyl pyridines, etc. The photoreactive materials may also include moieties located on the matrix support such as low index unsaturation (e.g., vinyl ether) to which acenaphthylene or other higher index group can photodimerize with. In such scenarios whereby a photoreactive material is used, the photoreactive material absorbs the recording light to form holographic gratings and then may absorb erasing light to erase the holographic gratings. Such materials may also be subjected to pre-curing and/or post-curing, as described below.

In addition to the at least one photoactive polymerizable material, the holographic storage medium may contain a photoinitiator which, upon exposure to relatively low levels of the recording light, chemically initiates the polymerization of the photoactive polymerizable material. From about 0.1 to about 20 vol. % photoinitiator may provide suitable results. The photoinitiators used may be sensitive to ultraviolet and visible radiation of from about 200 nm to about 800 nm. A variety of photoinitiators known to those skilled in the art and available commercially are suitable for use in the holographic storage medium, including free radical photoinitiators such as bis(η-5-2,4-cyclopentadien-1-yl)bis[2,6-difluoro-3-(1H-pyrrol-1-yl)phenyl]titanium, available commercially from Ciba as Irgacure 784™, 5,7-diiodo-3-butoxy-6-fluorone, commercially available from Spectra Group Limited as H-Nu 470, dye-hydrogen donor systems such as eosin, rose bengal, erythrosine, and methylene blue, and suitable hydrogen donors include tertiary amines such as n-methyl diethanol amine. In the case of cationically polymerizable components, a cationic photoinitiator may be used, such as a sulfonium salt or an iodonium salt which absorbs predominantly in the UV portion of the spectrum, which may be sensitized with a sensitizer or dye to allow use of the visible portion of the spectrum, or alternatively visible cationic photoinitiator such as (η₅-2,4-cyclopentadien-1-yl) (η₆-isopropylbenzene)-iron(II) hexafluorophosphate, available commercially from Ciba as Irgacure 261.

The holographic storage medium may also include additives such as plasticizers for altering the properties thereof including the melting point, flexibility, toughness, diffusibility of the monomers, ease of processibililty, etc. Examples of suitable plasticizers include dibutyl phthalate, poly(ethylene oxide) methyl ether, N,N-dimethylformamide, etc. Other types of additives that may be used in the holographic storage medium are inert diffusing agents having relatively high or low refractive indices. Inert diffusing agents typically diffuse away from the hologram being formed, and can be of high or low refractive index but are typically low. Thus, when, for example, a monomer of high refractive index is used, the inert diffusing agent may be of low refractive index, and ideally the inert diffusing agent diffuses to the nulls in an interference pattern. Overall, the contrast of the hologram may be increased. Other additives that may be used in the holographic storage medium include: pigments, fillers, nonphotoinitiating dyes, antioxidants, bleaching agents, mold releasing agents, antifoaming agents, infrared/microwave absorbers, surfactants, adhesion promoters, etc.

In addition to the photopolymeric systems described above, various other photopolymeric systems may be used in the holographic storage mediums. For example, suitable photopolymeric systems for use herein are also described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), Aug. 24, 2004; U.S. Patent Application No. 2003-0206320, published Nov. 6, 2003, (Cole et al), and U.S. Patent Application No. 2004-0027625, published Feb. 12, 2004, the entire contents and disclosures of which are herein incorporated by reference.

Articles comprising a holographic storage medium used in embodiments of the present invention may be of any thickness needed. For data storage applications, the article may be from about 0.2 to about 2 mm, more typically from about 1 to about 1.5 mm in thickness, and may be in the form of a film or sheet of holographic storage medium positioned between two substrates (e.g., sandwiched between the substrates) with at least one of the substrates having an antireflective coating and may be sealed against moisture and air. An article of the present invention may also be made optically flat via the appropriate processes, such as the process described in U.S. Pat. No. 5,932,045 (Campbell et al.), issued Aug. 3, 1999, the entire contents and disclosure of which is herein incorporated by reference.

Embodiments of an article may be of various sizes and shapes. The article may have a circular-shaped configuration (commonly referred to as a “disk,” “DVD,” “MO,” or “CD” format), or it may have other shapes, configurations, etc., including oval, square, rectangular, etc., for example, a square-shaped configuration commonly referred to as a “coupon” format. The size of the article in terms of width/length, diameter, etc., may be of any suitable dimension. For example, for CD formats, the article may have a diameter of from about 25 to about 140 mm, more typically from about 120 to about 130 mm.

### Description of Pre-Curing/Post-Curing and System for Carrying Out Same Generally

### Pre-Curing of Holographic Storage Media

Pre-curing of holographic storage media, including method and systems for carrying out pre-curing, which may be used in embodiments of the methods of the present invention are disclosed in, for example, U.S. application Ser. No. 11/440,370, entitled “Illuminative Treatment of Holographic storage media,” filed May 25, 2006, the entire disclosure and contents of which are hereby incorporated by reference. Subjecting a holographic storage medium at one or more points in the data storage cycle to illuminative treatment may provide: (1) enhanced or optimized the writing of holograms; or (2) enhance or optimized recovery of written holograms.

Uncured holographic storage media may not write holograms in an optimal or even acceptable fashion. For example, the uncured holographic storage media may not initially write holograms at all or may write holograms that are not stable over time. Uncured holographic storage media may also exhibit an inherent disadvantageous media response behavior. In other words, the uncured media is unable to write stable holograms, or writes stable holograms only by using greatly increased exposure times (at relatively slower data transfer rates) or by using exposure times which vary significantly relative to exposure times of holograms written in the same or similar sequence in the same volume of the media.

These poorer or less than optimal writing properties may be due to a number of factors. One factor which may adversely affect the ability of uncured holographic storage media to write holograms is the presence of polymerization inhibitors, especially oxygen, within the medium. For example, oxygen may be incorporated into the uncured holographic storage medium during processing, or may diffuse into the medium over time (e.g., within weeks or months) prior to use of the medium. When the uncured holographic storage medium is initially illuminated by a photoinitiating light source (e.g., recording light), the photoinitiator which is present may form multiple free radicals that catalyze or activate the reaction of the polymerizable components (e.g. monomers) that create the polymers generating or forming the holograms in the medium. Unfortunately, these free radicals may also preferentially react with any available oxygen (and/or other inhibitors), rather than the polymerizable components. Until this reservoir of oxygen is essentially used up or depleted, the medium may not be able to effectively create the polymers necessary to generate or form the holograms. In other words, holograms initially may not form at all in the uncured holographic storage medium.

Another factor which may adversely affect the ability of uncured holographic storage media to write holograms is the rate at which the photoinitiators, polymerizable and polymerized components, etc., diffuse through the holographic storage medium. Uncured holographic storage media may have an essentially inherent disadvantageous media response behavior because of the more rapid rate of polymer diffusion, as well as the changing rate of polymer diffusion. Initially, the physical size of the photoinitiators, polymerizable components, etc., relative to the support matrix of the medium, may be such that the initial polymer chains formed during exposure to the photoinitiating light (e.g., recording light) may rapidly diffuse through the medium. This initial rapid rate of diffusion may be so fast that the forming holograms do not become fixed or stable in the medium, but instead degrade or disappear because the polymer chains generating or forming these holograms simply diffuse into indistinct and unreadable structures. As the number of polymer chains increases with additional exposure to the recording light, the diffusion rate will eventually decrease and newly formed holograms will have far greater stability. Even so, the medium may still exhibit a disadvantageous media response behavior in writing holograms for some time because of the rapidly changing rate of polymer diffusion.

While the transition from the disadvantageous media response region to the relatively advantageous media response region may be partially compensated for by the holographic data storage system (e.g. by initially using a significantly varying exposure schedule to record holograms), this may be difficult to achieve in practice due to the rapidly changing nature of the media response and, hence, the relatively high level of uncertainty regarding the required exposure times. The writing properties of uncured holographic storage media may be improved by subjecting the uncured medium (or at least a portion of the uncured medium) prior to writing of holograms to illuminative curing to provide a pre-cured medium (or pre-cured portion of the medium) having an increased ability to stably record holograms. In illuminative pre-curing, this increased ability to stably write holograms is achieved because of one or more of the following factors: (1) the reservoir of available oxygen (and/or other inhibitors) in the medium is consumed or depleted, and thus unavailable to preferentially react with free radicals formed by the photoinitiator; (2) large polymer chains are initially formed to minimize or prevent the rapid diffusion of polymer chains which are later created during hologram writing through the support matrix so that stable holograms may be formed; and (3) enough polymer chains are created to further reduce, diminish, retard, etc., the diffusion rate to one which is the same or similar to the average diffusion rate over most of the dynamic range of the medium. In addition, pre-curing may bias the medium into the relatively advantageous media response region of the media response curve such that holograms may be written using the same or a similar amount of exposure to recording light, i.e., using the same or similar recording time, while still achieving the same or similar diffraction efficiencies. The ability to write holograms in pre-cured portions of the medium having a relatively advantageous media response behavior may also lead to increased storage capacity and increased data transfer rates for the medium.

In pre-curing of the holographic storage medium, the uncured medium (or portion thereof) may be subjected to, for example, illuminative curing by a curing beam having reduced coherence and a substantially uniform intensity distribution to increase, enhance, optimize, etc., the ability of the medium to stably write holograms. Pre-curing may be carried out so that the pre-cured portions of the medium are biased into the relatively advantageous media response region of the media response curve. The particular conditions under which pre-curing is carried out may depend on a number of factors, including the composition of the holographic storage medium to be pre-cured, how much of the medium is to be pre-cured, the wavelength of the recording light used to write holograms after pre-curing, etc. Pre-curing may be carried out with a curing beam having a wavelength that is different from that of the recording light used to subsequently write holograms, but is often carried out with a curing beam having the same or similar wavelength as the recording light used to write the holograms to simplify the pre-curing process.

The period of time (duration) that the uncured medium (or portion thereof) is subjected to illuminative curing with the curing beam may be according to a previously determined schedule based on prior pre-curing of holographic storage media having the same or a similar composition, using a curing beam having the same or a similar wavelength, etc. Alternatively, after subjecting the portion(s) of the holographic storage medium to illuminative curing with the curing beam for a period of time believed to be sufficient to provide a suitable pre-cured portion(s) of the medium having the desired ability to write stable holograms, the pre-cured portion(s) of the medium may be evaluated or analyzed by writing one or more test holograms and then determining, from these written test holograms, whether the pre-cured portion(s) of the medium have been biased into the relatively advantageous media response region based on the known media response curve of the medium. Alternatively, the progress of pre-curing may be determined by monitoring the luminescence of photoactive luminescent materials (e.g., photoactive fluorescent materials, photoactive phosphorescent materials, etc.) present in the medium or even by monitoring the intensity of the transmitted light (as a measure of the absorbance of the photoinitiators or photoreactive materials which may change in accordance with their concentration).

### Post-Curing of Holographic Storage Media

Post-curing of holographic storage media, including method and systems for carrying out post-curing, which may be used in embodiments of methods of the present invention are disclosed in, for example, U.S. application Ser. No. 11/440,367, entitled “Post-Curing of Holographic Media,” filed May 25, 2006, the entire disclosure and contents of which are hereby incorporated by reference. Holographic storage media, even after a significant amount of holograms have been written to use up much of the dynamic range (e.g. in the range from about 70 to about 90% of the total dynamic range), may still retain residual sensitivity to subsequent exposure to light sources. This residual sensitivity may manifest itself by the writing of additional undesired holograms (e.g., noise holograms) by the holographic storage medium due to, for example, the self-interference of coherent light beams used for recovering or reconstructing the holograms, etc. These additional undesired holograms may degrade or impair the ability to recover and reconstruct the written holograms by, for example, obscuring the holograms, significantly decreasing the signal to noise ratio (SNR), etc. It has been further discovered that, after a significant number of holograms been written by the holographic storage medium (e.g., in the range of from about 70 to about 90% of the total dynamic range has been used), the medium may also tend to write holograms more slowly and in an a more variable fashion, i.e., the media response curve of the medium is now in another disadvantageous media response region. In other words, the “practicable” dynamic range of the holographic storage medium may be essentially used up in writing holograms.

One factor which may cause this residual sensitivity in holographic storage media is the presence of residual photoinitiator, residual photoactive polymerizable materials, residual photoreactive materials, etc., or any combination thereof. Residual photoinitiator may initiate or catalyze the formation of additional polymer chains that generate these additional undesired holograms. Residual photoactive polymerizable materials may provide the source materials to create the polymer chains that generate or form these additional undesired holograms. By contrast, the level of residual photoinitiator and/or photoactive polymerizable materials may be sufficiently low, especially after most of the dynamic range has been used up, to require the use of greatly increased exposure times to write additional desired holograms having equal or nearly equal diffraction efficiencies (i.e., a disadvantageous media response behavior). In other words, the writing of additional holograms to the holographic storage medium is no longer as efficient (i.e., reflecting slower data transfer rates) as when the holograms are written, for example, in the relatively advantageous media response region of the media response curve.

This residual sensitivity of holographic storage media may be improved according to embodiments of the present invention by subjecting the holographic storage medium, after the writing of holograms has reached a desired level in terms of the percentage of the total dynamic range used, to illuminative curing with a curing beam having reduced coherence and a substantially uniform intensity distribution to minimize, reduce, eliminate etc., this residual sensitivity to writing additional undesired holograms (e.g. noise holograms). Essentially, post-curing uses up the residual photoinitiator, residual photoactive polymerizable materials, or both, until the level these materials is minimized, reduced, diminished, etc., to the point that undesired holograms, such as noise holograms, are minimally formed or do not form in the holographic storage medium. By reducing or eliminating the formation of these additional undesired holograms through the use post-curing of the holographic storage medium, the holograms written in the medium may be readily reconstructed and read by the holographic data storage system. In addition, post-curing may be carried out at or after the point where the “practicable” dynamic range of the holographic storage medium has been essentially used up, e.g. when from about 70 to about 90% of the total dynamic range of the medium has been used up.

The particular conditions under which post-curing is carried out may depend on a number of factors, including the composition of the holographic storage medium to be post-cured, the degree to which the total dynamic range of the medium has been used up, etc. Post-curing may be carried out at an appropriate wavelength, intensity, and for a period of time such that the residual sensitivity of the portion(s) of the medium written to (e.g., as reflected by the level of residual photoinitiator, residual photoactive polymerizable components, or both) has been reduced, lowered, diminished, etc., so that the portion(s) of the medium written to are unable to form additional undesired holograms (e.g., noise holograms), including those due to self-interference of a coherent light beam used for reconstructing and reading holograms, in sufficient quantities to adversely affect the written holograms, e.g., decrease the SNR. Post-curing may be carried out with a curing beam having a wavelength that is different from that of the recording light used to write the holograms, but may also be carried out with a curing beam having the same or similar wavelength as the recording light used to write holograms to simplify the post-curing process. Post-curing may be carried out for a period of time (duration) previously determined to be suitable based on prior post-curing of holographic storage media having the same or a similar composition, using a curing beam having the same or a similar wavelength, etc. Alternatively, the rate of absorption of the curing beam by the holographic storage medium may be measured during the post-curing process itself. When the rate of change of absorption of the curing beam drops or falls below a certain predetermined value (e.g. as predetermined for holographic storage media having the same or similar properties, composition, etc.), thus indicating completion of post-curing, post-curing may then be terminated. Alternatively, the progress of post-curing may be determined by monitoring the luminescence of photoactive luminescent materials (e.g., photoactive fluorescent materials, photoactive phosphorescent materials, etc.) present in the portion(s) of the medium.

After post-curing, substantially all of the dynamic range of the pre-cured portion is used up, e.g. from about 95 to 100% of the total dynamic range, more typically from about 99 to 100% of the total dynamic range. When the written portion of the holographic storage medium has been pre-cured, as described above, the pre-cured written portion may often be post-cured because pre-curing may sufficiently activate the pre-cured written portion of the medium so as to potentially increase the probability of writing undesired (e.g. noise) holograms, especially over the passage of time.

Combinations of Pre-Curing, Post-Curing and Writing into Media

Pre-curing and post-curing may be used in combination embodiments of the method of the present invention, including in combination with writing stacks of holograms to the recordable section of the holographic storage medium. In an embodiment, pre-curing of an uncured portion of the medium, or post-curing of a written portion of the medium, may be concurrently carried out while holograms are being written to a different portion of the medium. In another embodiment, post-curing may be carried out on a holographic storage medium having a written portion and a pre-cured unwritten portion, for example, to close out or finish the entire medium, or to close out or finish a selected sector or portion of the medium, so that no additional holograms may be written (e.g. unavoidably or by accident) in the finished medium, or in the finished sector or portion of the medium. In another embodiment, pre-curing may be carried out in a portion of the recordable section of the holographic storage medium, followed by writing holograms to the pre-cured portion to provide a written portion, followed by post-curing of the written portion to provide a post-cured written portion.

Illuminative Treatment Systems for Carrying Out Pre-Curing and/or Post-Curing

The illuminative treatment systems for carrying out such pre-curing and post-curing of holographic storage medium may comprise: (a) an illuminative treatment beam (i.e., a curing beam); and (b) means for transmitting the illuminative treatment beam to cause illuminative treatment (i.e., illuminative curing) of an uncured portion of a holographic storage medium to provide pre-cured portions having increased ability to write holograms.

A variety of sources of non-recording light may be used to generate the illuminative treatment beam (i.e., a curing beam) in these illuminative treatment process and systems. For example, the primary laser may be used to generate the data beam and/or reference beam may be used as the illuminative treatment beam in carrying out illuminative curing. Alternatively, one or more other, auxiliary lasers may be used as the source of the illuminative treatment beam. The use of lasers as the source of the illuminative treatment beam may provide high power transmission and coupling efficiency, and have lower numerical aperture (and hence size) requirements because of the ability to control beam divergence more closely.

Light emitting diodes (LEDs) may also be used as the source of the illuminative treatment beam. A single LED may be used as the illuminative treatment beam, or an array of LEDs may be used to achieve higher peak power levels in the illuminative treatment beam. Use of an LED(s) may also provide a relatively reduced coherence illuminative treatment beam which does not interfere with itself and thus produce interference fringes or other undesired diffraction effects that may degrade the quality of the illuminative treatment that is carried out on the holographic storage medium. The LED(s) used to provide the illuminative treatment beam may generate a single wavelength or may be adjustable to generate different wavelengths of light.

The illuminative treatment beam may be dithered in angle or position to enhance the uniformity of the effect of the illuminative treatment beam on the holographic storage medium. Because of the coherence of laser beams, illuminative treatment systems using such illuminative treatment beams may be designed in such a way as to control, minimize or eliminate coherent noise (fringing, diffraction, etc.) that may cause undesirable effects (e.g., “striations,” etc.) in the holographic storage medium due to non-uniform illuminative treatment and may ultimately be a source of noise holograms, SNR degradation, etc. Coherence of the illuminative treatment beam may be reduced, for example, to less than the thickness of the holographic storage medium. Coherence reduction may be achieved by including a diffuser in the illuminative treatment system pathway to thus cause the illuminative treatment beam to have different optical phases across the hologram and reduce the chance of self-interference. Motion may be imparted to the diffuser such as oscillation, vibration, etc., for the purpose of reducing temporal coherence by blurring out over time any localized intensity variations caused by self-interference with the illuminative treatment beam. Use of a diffuser may have a further advantage of creating a more uniform intensity distribution or profile to during illuminative treatment. Another approach for achieving coherence reduction that may provide a more compact system design is to use integrating rods for the transmitting the illuminative treatment beam, wherein the multiple refractions and/or reflections of the illuminative treatment beam within the rods may serve to diffuse the beam. Yet another approach for achieving coherence reduction is to modulate the electrical current to the source of the illuminative treatment beam (e.g., laser) with a high frequency (e.g., hundreds of megaHertz) signal so as to cause the temporal mode structure of the illuminative treatment beam to be multimode (i.e., multi-wavelength), thus reducing the coherence of the beam and the ability to self-interfere. Yet another approach for achieving coherence reduction is to use a rapidly scanning reference beam as the illuminative treatment beam.

The diffusion angle should be large enough to achieve coherence reduction in the illuminative treatment beam, but also small enough to enable as much of the light as possible in the beam to pass through the illuminative treatment system. To further increase the uniformity of the illuminative treatment process, the diffuser may be moved during illuminative treatment by translation, vibration, rotation, etc., which may smooth out any intensity variations at the holographic storage medium plane caused by the diffuser itself, or by self-interference of the illuminative treatment beam. To achieve adequate blurring by this technique, the motion imparted to the diffuser should be sufficient to move the diffuser many of its own correlation lengths during illuminative treatment. Suitable linear and/or rotational motion may be imparted to the diffuser, for example, by linear or rotary stages driven, for example, by stepper (discrete) or DC-servo motors (continuous). Such a diffuser design should also not substantially blur the edges of the treated area, nor cause a significant loss of transmission of the illuminative treatment beam through the illuminative treatment system. For example, this may be achieved by using a diffuser that has a small diffusion angle of a few degrees or less, and/or by placing the diffuser in a location that is not in an image plane of the holographic storage medium.

The illuminative treatment beam may have the same wavelength as that used in writing holograms, or the illuminative treatment beam may have a different wavelength(s) chosen to enhance or optimize a specific characteristic of the treated holographic storage medium (e.g. to provide peak or maximum absorption of the beam by photoactive materials present in the medium), or to perform a specific illuminative treatment process. For example, an illuminative treatment beam having a shorter wavelength may increase absorption and thus increase the speed of illuminative treatment. If auxiliary laser beams are used as the source of the illuminative treatment beam, the illuminative treatment beam may be transmitted through the existing components of the holographic data storage system to cause illuminative treatment of the holographic storage medium. Alternatively, a beam splitter may be used to inject a separate auxiliary beam as the illuminative treatment beam, of the same or a different wavelength, at some appropriate point into the reference beam path so that the illuminative treatment beam is transmitted to cause illuminative treatment of the holographic storage medium. In some embodiments, the auxiliary beam(s) may be injected into the data beam path instead of, or in addition to, the reference beam path for transmission as an illuminative treatment beam to cause illuminative treatment of the holographic storage medium. The source of illuminative treatment beam may also be provided by a separate beam path using a different set of transmission components (e.g., a different optical path) to carry out illuminative treatment of the holographic storage medium. The path for transmitting the illuminative treatment beam may cause illuminative treatment to be carried out at the same location in the system where holograms are written to and/or reconstructed/read from the holographic storage medium, or at a different location in the system where only illuminative treatment of the holographic storage medium is carried out.

A fiber optic or fiber optic bundle may be used to transmit the illuminative treatment beam from a laser, LED, or an array of lasers or LEDs, to other components for transmitting the illuminative treatment beam to cause illuminative treatment of the holographic storage medium. A single- or multi-element lens may be used to collect some of the light from a single laser or LED to provide a collected illuminative treatment beam, and then to transmit that collected illuminative treatment beam towards the holographic storage medium to be subjected to illuminative treatment. Because light from a laser, LED or array thereof may diverge, a multi-element lens may also be used to increase the collection efficiency of the illuminative treatment beam used in the illuminative treatment system. A matched lenslet array may also be used to approximately collimate the light from the individual lasers or LEDs, or arrays thereof to provide a collimated illuminative treatment beam and to transmit the collimated illuminative treatment beam towards the holographic storage medium to be subjected to illuminative treatment. Alternatively, single or multiple lasers or LEDs may be coupled to a fiber optic or fiber optic bundle to enable optical power transmission of the illuminative treatment beam to a remote point or location for carrying out illuminative treatment of the holographic storage medium.

The illuminative treatment beam may be transmitted to provide a substantially uniform intensity distribution during illuminative treatment. The illuminative treatment beam may also be formed or otherwise shaped to cause illuminative treatment of only a selected portion or portions of the holographic storage medium, or all of the holographic storage medium. Such shaping of the illuminative treatment beam may be desirably carried out with minimal power losses and using as little space as possible or practicable in the system. Shaping of the illuminative treatment beam may be achieved by using the combination of a lenslet array and a transform (i.e., focusing) lens. The lenslet or lenslets may have physical apertures which, when transformed by the lens, form or create the shape of the desired illumination area on the holographic storage medium, and may be any of desired configuration, including square-shaped, rectangular-shaped, hexagonal-shaped, circular-shaped, oval- or elliptical-shaped, etc. In addition, the illuminated area provided by the lenslet or lenslet array may be altered by simply changing individual lenslets or multiple lenslets in the array depending upon the illuminated area desired. A transform lens may be used in this combination to effectively collimate each separate beam from each lenslet, and thus cause some or all of the lenslet beams to overlap in the area or portion of the holographic storage medium being subjected to illuminative treatment. The transform lens may also break up the wave boundary of the illuminative treatment beam so as to reduce the spatial coherence of the beam, thus helping to reduce, minimize or eliminate coherent noise effects in the illuminative treatment beam. Shaping of the illuminative treatment beam may also be achieved by using a physical aperture, imaging an illuminated aperture; imaging a shaped and/or apertured end of an optic fiber, etc.

The illuminative treatment beam may also be transmitted, for example, by a fiber optic bundle, light pipe, etc., or combined with an appropriate physical aperture to form a specific illumination pattern, such as one that matches the “footprint” of the holographic recording area on the holographic storage medium. The transmitted illuminative treatment beam may also be coupled to an additional lens assembly, which images the output end of a fiber optic bundle, a physical aperture or a shaped aperture in a lens and/or fiber optic assembly, to a point, area, portion, etc., on the holographic storage medium where illuminative treatment is to be carried out so as to maximize the illuminative treatment efficiency.

The speed of the illuminative treatment may depend on the amount of light power absorbed by the holographic storage medium. To increase the rate or speed of illuminative treatment, the holographic storage medium may be subjected to multi-pass illuminative curing. Some portion of the illuminative treatment beam often passes through and is not absorbed by the holographic storage medium. In multi-pass illuminative curing, all or a portion of the unabsorbed illuminative treatment beam that passes through may be reflected back through the holographic storage medium to effect additional illuminative treatment (i.e., pre-curing). The unabsorbed illuminative treatment beam that is transmitted to one side and passes through the holographic storage medium may be reflected back by any suitable optical device or devices positioned on the opposite side of the medium, for example, a mirror, (e.g. a flat mirror or parabolic mirror), a combination of one or more lenses and a mirror, etc., to achieve multi-pass illuminative curing. The reflected illuminative treatment beam may also be manipulated, controlled, influenced, etc., to improve, control, correct, etc., the treatment beam's direction, focus, illuminative profile, etc., by using one or more optical devices, for example parabolic mirrors, lenses, combination of one or more lenses and mirror, etc. Such multi-pass illuminative curing may significantly reduce the time required to achieve the desired degree of illuminative curing of the holographic storage medium.

The illuminative treatment beam may be transmitted to treat all of or the entire holographic storage medium, or only a selected sector or portion thereof which may have an annular or ring shape, a wedge or pie shape, etc. Where the size of the illuminative treatment beam is such that the beam does not cover all of a selected portion of the holographic storage medium to be treated, the holographic storage medium may be moved relative to the beam while the selected portion of the medium to be treated is simultaneously and continuously illuminated with the beam. In one embodiment, movement of the medium is carried out by substantially linear translation of the medium. In an alternative embodiment, movement of the medium may alternate between: (1) a substantially linear translation in a first direction; and (2) a substantially linear translation in a second direction which is transverse (e.g., substantially orthogonal) to the first direction. In another embodiment, movement of the medium may be carried out by continuous, unidirectional rotation of the medium. In another embodiment, movement of the medium may be carried out by alternating between: (1) continuous, unidirectional rotation of the medium; and (2) a substantially linear translation of the medium. In another embodiment, the selected portion of the medium may be incrementally illuminated with illuminative treatment beam at discrete locations to provide a treated portion having contiguous or nearly contiguous tiled geometry.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A method comprising the following steps:
(a) providing a holographic storage medium having a recordable section comprising a plurality of bookcases having one or more cure sites, each cure site corresponding to one cure spot, wherein one or more pre-cure boundaries are established to define one or more bounded pre-cure areas comprising one or more bookcases; and
(b) for each bounded pre-cure area, carrying out a pre-curing and stack writing routine at the one or more cure sites within the one or more bookcases such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases within a pre-cure active recording period.

2. The method of claim 1, wherein the holographic storage medium of step (a) comprises a circular-shaped disk, and wherein the recordable section has an annular shape.

3. The method of claim 2, wherein the recordable section of step (a) comprises a multiplicity of cure sites which are arranged in a plurality of concentric tracks.

4. The method of claim 3, wherein the one or more cure boundaries of step (a) comprises one cure boundary established approximately at the radial midpoint of the recordable section so as to provide an inner pre-bounded cure area and an outer bounded cure area.

5. The method of claim 3, wherein the pre-curing and stack writing routine of step (b) is carried out in a manner starting at a cure site and progressing radially and outwardly therefrom in a generally wave-like pattern.

6. The method of claim 5, wherein the plurality of concentric tracks of step (a) progress outwardly from an inner most track to an outer most track, and wherein the starting cure site is within the inner most track or the outer most track.

7. The method of claim 6, wherein the starting cure site is within the outer most track.

8. The method of claim 6, wherein the starting cure site is within the inner most track.

9. The method of claim 5, wherein the wave-like pattern of step (b) generates a pre-cure wave boundary having a circumference defining a pre-cure wave boundary area, and wherein the one or more cure boundaries of step (a) are established so as to guide the pre-cure wave boundary and limit the circumference of the pre-cure wave boundary to a size such that the pre-cure wave boundary area has a writable portion having a same or similar size during step (b) up until almost the end of stacks of holograms being written to the writable portion.

10. The method of claim 1, wherein the pre-cure boundary of step (a) comprises one pre-cure boundary defining a bounded inner pre-cure area and a bounded outer pre-cure area, and wherein each of the bounded pre-cure areas have a size such that all stacks of holograms may be written radially across each bounded pre-cure areas during step (b) within the respective pre-cure active recording period.

11. The method of claim 1, wherein pre-curing during step (b) is carried out so as to tile the pre-cured spots.

12. The method of claim 11, wherein pre-curing during step (b) is carried out so as to tile the pre-cured spots across the entire recordable sections.

13. The method of claim 11, wherein each of the pre-cured spots has an intensity profile comprising a maximum intensity central plateau region, an adjacent beginning upward sloped region, and an adjacent ending downward sloped region, and wherein pre-curing during step (b) is carried out so that the beginning and ending sloped regions of each overlapping tiled pre-cured spot receives up to about 50% of the pre-curing energy received by the central plateau region of each overlapping tiled pre-cured spot.

14. The method of claim 1, wherein step (b) is carried out by writing each stack of holograms to a previously assigned bookcase.

15. The method of claim 1, wherein step (b) is carried out by completely writing all stacks of holograms to one of the bookcases to provide a finished bookcase before any stacks of holograms are written to another bookcase.

16. The method of claim 1, where the one or more bounded pre-cure areas of step (a) comprise up to twenty bounded pre-cure areas.

17. The method of claim 1, wherein each pre-cure active recording period during step (b) is in the range of from about 10 to about 20 minutes.

18. The method of claim 1, where the one or more bookcases of step (a) each comprise the same number of cure sites.

19. The method of claim 1, wherein at least some of the one or more bookcases of step (a) comprise a different number of cure sites.

20. A method comprising the following steps:
(a) providing a holographic storage medium having a recordable section comprising first bounded pre-cure area and a second bounded pre-cure area, wherein each of the first and second bounded pre-cure areas comprise one or more bookcases, each bookcase having one or more cure sites;
(b) within the first bounded pre-cure area and for the one or more bookcases within the first bounded pre-cure area, carrying out a pre-curing and stack writing routine at the one or more cure sites within the one or more bookcases of the first bounded pre-cure area such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases of the first bounded pre-cure area within a first pre-cure active recording period; and
(c) after step (b) is completed, within the second bounded pre-cure area and for the one or more bookcases within the second bounded pre-cure area, carrying out a pre-curing and stack writing routine at the one or more cure sites within the one or more bookcases of the second bounded pre-cure such that: (1) each cure spot to which stacks of holograms are to be written and each neighboring cure spot are pre-cured so as to have a constant intensity profile prior to the writing of any stacks of holograms to the each cure spot; and (2) all stacks of holograms are written to the one or more bookcases of the second bounded pre-cure area within a second pre-cure active recording period.

21. The method of claim 20, wherein the holographic storage medium of step (a) comprises a circular-shaped disk, and wherein the recordable section has an annular shape.

22. The method of claim 21, wherein the recordable section of step (a) comprises a multiplicity of cure sites which are arranged in a plurality of concentric tracks.

23. The method of claim 22, wherein first and second bounded pre-cure areas of step (a) are separated by a pre-cure boundary comprises one cure boundary established approximately at the radial midpoint of the recordable section so that the first bounded pre-cure area is an inner pre-bounded cure area and so that the second bounded pre-cure area is an outer bounded cure area.

24. The method of claim 22, wherein the pre-curing and stack writing routine of each of steps (b) and (c) is carried out in a manner starting at a cure site within one of the one or more bookcases and progressing radially and outwardly therefrom in a generally wave-like pattern.

25. The method of claim 24, wherein each of the first and second bounded pre-cure areas comprises plurality of concentric tracks of step (a) which progress outwardly from an inner most track to an outer most track, and wherein the starting cure site of steps (b) and (c) is within the inner most track or the outer most track of each bounded pre-cure area.

26. The method of claim 24, wherein the wave-like pattern of step (b) generates a pre-cure wave boundary having a circumference defining a pre-cure wave boundary area, and wherein the one or more cure boundaries of step (a) are established so as to guide the pre-cure wave boundary and limit the circumference of the pre-cure wave boundary to a size such that the pre-cure wave boundary area has a writable portion having a same or similar size during step (b) up until almost the end of stacks of holograms being written to the writable portion.

27. The method of claim 20, wherein the pre-cure boundary of step (a) comprises one pre-cure boundary defining a bounded inner pre-cure area and a bounded outer pre-cure area, and wherein each of the bounded pre-cure areas have a size such that all stacks of holograms may be written radially across each bounded pre-cure areas during step (b) within the respective pre-cure active recording period.

28. The method of claim 20, wherein pre-curing during step (b) is carried out so as to tile the pre-cured spots.

29. The method of claim 28, wherein pre-curing during step (b) is carried out so as to tile the pre-cured spots across the entire recordable sections.

30. The method of claim 29, wherein each of the pre-cured spots has an intensity profile comprising a maximum intensity central plateau region, an adjacent beginning upward sloped region, and an adjacent ending downward sloped region, and wherein pre-curing during step (b) is carried out so that the beginning and ending sloped regions of each overlapping tiled pre-cured spot receives up to about 50% of the pre-curing energy received by the central plateau region of each overlapping tiled pre-cured spot.

31. The method of claim 20, wherein steps (b) and (c) are carried out by completely writing all stacks of holograms to one of the bookcases to provide a finished bookcase before any stacks of holograms are written to another bookcase.

32. The method of claim 20, wherein each pre-cure active recording period during step
(b) is in the range of from about 10 to about 20 minutes.

33. A method comprising the following steps:
(a) determining the positioning of a multiplicity of cure sites on a recordable section of a holographic storage medium so as to provide corresponding cure spots having a constant intensity profile across the entire recordable section, wherein each cure site corresponds to one of the cure spots;
(b) determining the positioning of all stacks of holograms to be written to the recordable section such that each stack of holograms can be written to at least one of the cure spots;
(c) determining which of the at least one cure spots each of the stacks of holograms will be written to; and
(d) determining which of the cure spots are to be grouped into each of a plurality of bookcases.

34. The method of claim 33, wherein the holographic storage medium of step (a) comprises a circular-shaped disk, and wherein the recordable section has an annular shape.

35. The method of claim 33, wherein the multiplicity of cure sites of step (a) are arranged in a plurality of concentric tracks.

36. The method of claim 33, wherein step (d) is carried out by grouping an equal number of cure spots into each of the bookcases.

37. The method of claim 33, wherein step (d) is carried out by grouping a different number of cure spots into at least some of the bookcases.

38. The method of claim 33, wherein step (a) is carried out such that the cure spots are tiled across the recordable section.

39. A method comprising the following steps:
(a) determining which of a multiplicity of cure spots are to be grouped into each of a plurality of bookcases to be positioned on a recordable section of a holographic storage medium, wherein each cure spot corresponds to one cure site having a position on the recordable section;
(b) from all stacks of holograms to be written to the recordable section, determining which of the stacks of holograms are to be written to each bookcase; and
(c) for each bookcase, determining where each bookcase is to be positioned on the recordable section based on the position of the cure site for each cure spot within each bookcase.

40. The method of claim 39, wherein the holographic storage medium of step (a) comprises a circular-shaped disk, and wherein the recordable section has an annular shape.

41. The method of claim 39, wherein the multiplicity of cure spots of step (a) are arranged in a plurality of concentric tracks.

42. The method of claim 39, wherein step (a) is carried out by grouping an equal number of cure spots into each of the bookcases.

43. The method of claim 39, wherein step (a) is carried out by grouping a different number of cure spots into at least some of the bookcases.

44. The method of claim 39, wherein step (a) is carried out such that the cure spots are tiled across the recordable section.

45. A method comprising the following steps:
(a) providing a holographic storage medium having a recordable section comprising a plurality of bookcases, wherein each bookcase is positioned on the recordable section by using each cure site for each cure spot to be included within the bookcase and wherein each cure site is arranged in a row;
(b) for each bookcase, carrying out a first pre-curing and stack writing routine which comprises the steps of: (1) pre-curing a first cure spot within a first row and within the bookcase; (2) pre-curing all cure spots neighboring the first cure spot and which are not within a different bounded pre-cure area so as to provide a first pre-cured area having a constant intensity profile; and (3) writing one or more stacks of holograms to the first cure spot within the first row;
(c) for each bookcase when step (b) reaches the point where a stack of holograms is to be written to a second cure spot which has been pre-cured within the bookcase, carrying out a second pre-curing and stack writing routine which comprises the steps of: (1) pre-curing all cure spots neighboring the second cure spot which have not been pre-cured and which are not within a different bounded pre-cure area so as to provide a second pre-cured area having a constant intensity profile; and (2) writing one or more stacks of holograms to the second cure spot;
(d) as stacks of holograms to be written for each additional pre-cured cure spot after the second cure spot within the bookcase has been reached, repeating step (c) until all stacks of holograms to be written to the bookcase have been written; and
(e) repeating steps (b) through (d) until all stacks of holograms to be written to the bookcases have been written.

46. The method of claim 45, wherein the holographic storage medium of step (a) comprises a circular-shaped disk, and wherein the recordable section has an annular shape.

47. The method of claim 46, wherein the rows of step (a) comprise a plurality of concentric tracks.

48. The method of claim 45, wherein pre-curing during steps (b) through (e) is carried out so as to tile the pre-cured spots.

49. The method of claim 48, wherein pre-curing during steps (b) through (e) is carried out so as to tile the pre-cured spots across the entire recordable sections.

50. The method of claim 48, wherein each of the pre-cured spots has an intensity profile comprising a maximum intensity central plateau region, an adjacent beginning upward sloped region, and an adjacent ending downward sloped region, and wherein pre-curing during steps (b) through (e) is carried out so that the beginning and ending sloped regions of each overlapping tiled pre-cured spot receives up to about 50% of the pre-curing energy received by the central plateau region of each overlapping tiled pre-cured spot.

51. The method of claim 45, wherein steps (b) through (e) are carried out by writing each stack of holograms to a previously assigned bookcase.

52. The method of claim 45, wherein steps (b) through (e) are carried out by completely writing all stacks of holograms to one of the bookcases to provide a finished bookcase before any stacks of holograms are written to another bookcase.

53. The method of claim 45, wherein each pre-cure active recording period during steps (b) through (e) is in the range of from about 10 to about 20 minutes.

54. The method of claim 45, wherein step (a) is carried out by grouping an equal number of cure spots into each of the bookcases.

55. The method of claim 45, wherein step (a) is carried out by grouping a different number of cure spots into at least some of the bookcases.

56. The method of claim 45, which comprises the further step (f) of post-curing one or more cure spot to which stacks of holograms have been written to during one or more of steps (b), (c), (d) or (e).

57. The method of claim 56, wherein step (e) is carried out by post-curing all cure spots to which stacks of holograms have been written to during all of steps (b) through (e).
